(19) United States
(12) Patent Application Publication
(10) Pub. No.: US 2021/0229332 A1
(43) Pub. Date: Jul. 29, 2021

(54) INJECTION MOLDING DIE

(71) Applicant: Kumi Kasei Co., Ltd., Tokyo (JP)

(72) Inventor: Etsuo Okahara, Ube-shi (JP)

(21) Appl. No.: 15/734,688

(22) PCT Filed: Mar. 26, 2019
(86) PCT No.: PCT/JP2019/012862

§ 371 Date: Dec. 3, 2020

(30) Foreign Application Priority Data
Jun. 7, 2018 (JP) 2018-109796

(51) Int. Cl. B29C 45/34; B29C 45/26; B29C 45/40

(52) U.S. Cl. CPC B29C 45/34; B29C 45/40; B29C 45/261

(57) ABSTRACT

An injection molding die of the invention, includes: a cavity die having a molding recess formed thereon, the molding recess molding a molded-product main body on which a design surface of a resin molded product is formed; and a core die that exists to be openable and closable with respect to the cavity die and forms a cavity having the molding recess between the cavity die and the core die, when the core die is closed and coupled to the cavity die, and the injection molding die is used in a resin molding method of causing a design surface of the resin molded product during molding to be brought into close contact with the cavity die by setting temperatures of the cavity die and the core die to be higher than or equal to a deformation temperature of a resin to be molded.

### TECHNICAL FIELD

The present invention relates to an injection molding die.

This application claims priority from Japanese Patent Application No. 2018-109796 filed on Jun. 7, 2018, the contents of which are incorporated herein by reference in their entirety.

### BACKGROUND ART

For injection molding a resin molded product, in the case of molding a projected portion such as rib, boss, a clip for attachment, or the like on a back surface of a mold, if the above-mentioned projected portion is set to be thick, it was unavoidable that a recess referred to as a sink is generated at a position of a surface of the molded product which corresponds to the projected portion or unevenness of transfer is generated.

As a molding method of not generating the above-described sink, in the following Patent Documents 1 to 3, the temperature of an inner surface of a cavity die molding a design surface of a molded product is set to be higher than the temperature of a surface of a core die molding a back surface side of the molded product, and therefore the design surface side of the molded product is brought into close contact with a cavity surface of a die. Consequently, a technique (hereinbelow, referred to as a method of heating molding a design surface side) of concentrating generation of sink to the back surface side on the opposite side of the design surface and inhibiting the sink from being generated on the design surface is proposed.

In Patent Document 3, in the method of heating molding a design surface side, a die is proposed in which a thickness of a resin of a projected portion provided on a back surface of a molded product such as a rib is set to be in a predetermined range with respect to a thickness of a plate-shaped portion, and therefore prevention of sink on the design surface of the plate-shaped portion from being generated can be stably realized.

However, in the above-mentioned method of heating molding a design surface side, heat transfer from a cavity die having a high temperature to a core die occurs at a contact point between the cavity die and the core die which are in a mold clamping state. Consequently, a difference in temperature between the cavity die and the core die becomes low, in some cases, adhesive strength of a molding resin with respect to an inner surface of the cavity die was degraded.

Additionally, as described in Patent Document 3, even in the case where a thickness of the plate-shaped portion is set to be in a predetermined range with respect to a thickness of a resin of a projected portion such as a rib or the like provided on the back surface of the molded product, in some cases, it was not possible to prevent sink from being generated on the design surface depending on the location of the projected portion such as a rib or the like. For example, in the case where a region surrounded by ribs or the like is present or in the case where ribs or the like are arranged substantially parallel to each other, in some cases, it was not possible to prevent sink from being generated on the design surface.

Furthermore, in the case where a thickness of a rib or the like is less than a predetermined thickness with respect to a thickness of the plate-shaped portion, cooling of the rib or the like occurs previous to that of the plate-shaped portion, it is not possible to concentrate sink to the back surface, and in some cases, sink was generated on the design surface.

In addition, in the molding methods which are described in the above-mentioned Patent Documents and set the cavity surface to be higher than that of the core die surface in temperature, there was a problem in that warpage in a recessed shape is generated on the high-temperature side of the molded product that was removed therefrom.

### PRIOR ART DOCUMENTS

### Patent Documents

[Patent Document 1] Japanese Unexamined Patent Application, First Publication No. H6-315961

### [Patent Document 2] Japanese Unexamined Patent Application, First Publication No. 2012-192715

### [Patent Document 3] Japanese Unexamined Patent Application, First Publication No. 2015-223732

### SUMMARY OF THE INVENTION

### Problems to be Solved by the Invention

One aspect of the invention solves the above problem and provides an injection molding die that stably concentrates sink to a back surface of a molded product, can stably realize the prevention of sink on the design surface of the molded product from being generated, and causes warpage due to a difference in temperature of a die not to be generated on the molded product.

### Means for Solving the Problems

In order to solve the aforementioned problem, the invention provides the following aspect.

An injection molding die according to one aspect of the invention, includes: a cavity die having a molding recess formed thereon, the molding recess molding a molded-product main body on which a design surface of a resin molded product is formed; and a core die that exists to be openable and closable with respect to the cavity die and forms a cavity having the molding recess between the cavity die and the core die, when the core die is closed and coupled to the cavity die, the injection molding die being used in a resin molding method of causing a design surface of the resin molded product during molding to be brought into close contact with the cavity die by setting temperatures of the cavity die and the core die to be higher than or equal to a deformation temperature of a resin to be molded, wherein the injection molding die includes a temperature regulation mechanism that maintains the temperature of the core die to be substantially the same as the temperature of the cavity die, the core die has a back side molding surface, a projected-portion molding recess, and a ventilation pass, which are formed therein, the back side molding surface molds a back surface side on an opposite side of a top surface side on which the design surface is to be formed, by use of an inner surface of the molding recess of the cavity die of the molded-product main body, the projected-portion molding recess molds a projected portion that is depressed from the back side molding surface and protrudes from a back surface of the molded-product main body, the ventilation pass is formed to open at the back side molding surface and introduces gas from an outside of the cavity into an inside of the cavity, and an entirety of the back side molding surface of the core die is located in a range of 100 mm which is a shortest distance from an opening portion of the ventilation pass of the back side molding surface of the core die along the back side molding surface.

In the aforementioned injection molding die, a configuration may be adopted in which the core die has a tubular-projected-portion molding recess and the ventilation pass which are formed therein, the tubular-projected-portion molding recess is the projected-portion molding recess on which an opening portion endlessly extends on the back side molding surface, and molds the projected portion that surrounds a region of a part thereof and is formed in a tubular shape on a back surface of the molded-product main body, and the ventilation pass opens at an inside region surrounded by the tubular-projected-portion molding recess of the back side molding surface.

The ventilation pass may be an ejector pin hole that accommodates an ejector pin therein.

The core die includes: a core-die main body that forms a back side molding main surface that is part of the back side molding surface; and a bushing that is fixed to an inside of a bushing storage recess depressed from the back side molding main surface of the core-die main body, wherein a bushing top surface that is part of the back side molding surface is formed on the bushing, wherein a gas storage space is ensured between the bushing and the core-die main body by a recess formed on one or both of an inner surface of the bushing storage recess and the bushing, and the gas storage space may be connected to the cavity so as to be able to ventilate thereto via the ensured ventilation pass between an inner peripheral face of the bushing storage recess of the core-die main body and the bushing or in the bushing.

The core die includes a recess-divided-portion formation bushing serving as the bushing on which a recess-divided portion that is part of the projected-portion molding recess is formed, and one end of the ventilation pass may open at an inner surface of the projected-portion molding recess, and the ventilation pass is ensured at a matching portion between an inner peripheral face of the bushing storage recess of the core-die main body having part of the projected-portion molding recess formed therein and the recess-divided-portion formation bushing or a matching portion between the recess-divided-portion formation bushings.

### Effects of the Invention

According to the injection molding die of one aspect of the invention, it is possible to cause gas to enter between the resin molded product formed by solidification and contraction of the molten resin that is injected and filled to the cavity and the back side molding surface of the core die, through the ventilation pass. Consequently, due to contraction of the resin molded product, it is possible to separate the back surface of the resin molded product from the back side molding surface of the core die, it is possible to stably generate sink on the back surface side of the molded product, and the sink that is caused by reduction in volume of the resin molded product due to lowering of the temperature thereof after molding can be concentrated to the back surface side of the molded product. According to the injection molding die of one aspect of the invention, a degree of flexibility in sink that is caused by reduction in volume due to lowering of the temperature thereof after molding the projected portion such as a rib or the like present on the back surface side of the molded product can be improved. As a result, prevention of sink from being generated at the portion of the design surface of the molded product which corresponds to the projected portion of the resin molded product can be stably realized. According to the injection molding die, even where molding is carried out in a state where the temperature of the cavity die is substantially the same as the temperature of the core die, the sink that is caused by reduction in volume due to cooling can be concentrated to the back surface side of the molded product. Because of this, by using the injection molding die in a molding method that is carried out in a state where the temperature of the cavity die is substantially the same as the temperature of the core die, it is possible to prevent sink from being generated on the design surface of the molded product, and warpage of the molded product can also be prevented from being generated.

Moreover, according to the injection molding die of one aspect of the invention, even in the case where the projected portion such as a rib or the like on the back surface side of the molded product exists so as to surround a region of the back surface side of the molded product or the projected portions such as a rib or the like are closely arranged substantially parallel to each other, it is possible to stably prevent sink from being generated on the design surface of the molded product.

### BRIEF DESCRIPTION OF THE DRAWINGS

FIG. 1 is a cross-sectional front view showing an injection molding die according to a first embodiment of the invention.

FIG. 2 is a view showing a core die of the injection molding die of FIG. 1 and is a plan view showing a configuration when viewed from the back side molding surface side of the core die.

FIG. 3 is a view showing a resin molded product molded by use of the injection molding die of FIG. 1 and is a view showing a configuration when viewed from the back surface side of the resin molded product.

FIG. 4 is a cross-sectional front view showing the resin molded product of FIG. 3 (a view taken along the line A-A shown in FIG. 3.

FIG. 5 is a view explaining molding of the resin molded product by use of the injection molding die of FIG. 1 and is a cross-sectional front view showing a state where sink is generated on the molded-product-main-body back surface side by reduction in volume of the resin molded product due to lowering of the temperature thereof after molding.

FIG. 6 is a plan view showing a core die of Comparative Example.

FIG. 7 is a view showing a resin molded product that is molded by use of an injection molding die employing the core die of FIG. 6 and is a view showing a configuration when viewed from the back surface side of the resin molded product.

FIG. 8 is a cross-sectional view (a view taken along the line B-B shown in FIG. 8) showing a state where sink is generated at a portion of a design surface of the resin molded product of FIG. 8 which corresponds to a projected portion on the back surface side of the resin molded product.

FIG. 9 is a cross-sectional front view showing an injection molding die according to a second embodiment of the invention.

FIG. 10 is a view showing a core die of the injection molding die of FIG. 9 and is a plan view showing a configuration when viewed from the back side molding surface side of the core die.

FIG. 11 is a view showing a resin molded product molded by use of the injection molding die of FIG. 9 and is a view showing a configuration when viewed from the back surface side of the resin molded product.

FIG. 12 is a cross-sectional front view showing the resin molded product of FIG. 11 (a view taken along the line C-C shown in FIG. 11.

FIG. 13 is an enlarged plan view showing a configuration (particularly, existence of a storage-space connection ventilation pass) of a matching portion of an inner peripheral face of a bushing storage recess of a core-die main body of the core die of the injection molding die of FIG. 9 and a bushing side peripheral surface.

FIG. 14 is a view explaining molding of the resin molded product by use of the injection molding die of FIG. 11 and is a cross-sectional front view showing a state where sink is generated on the molded-product-main-body back surface side by reduction in volume of the resin molded product due to lowering of the temperature thereof after molding.

FIG. 15 is a cross-sectional front view showing a resin molded product that is molded by use of an injection molding die having a configuration in which a gas storage space, a storage-space connection ventilation pass, an ejector pin hole opening at a circumference-recess-inside region which are omitted from the core die regarding the injection molding die shown in FIGS. 9 and 10 and is a view showing a state where sink is generated at a portion of a design surface of the resin molded product which corresponds to a projected portion on the back surface side of the resin molded product.

FIG. 16 is a view showing another embodiment of a gas storage space of a core die and is a cross-sectional front view showing a configuration in which a gas storage space is ensured only by a recess (core-die gas storage recess) formed on an inside bottom surface of a bushing storage recess of a core-die main body.

FIG. 17 is a view showing another embodiment of a gas storage space of a core die and is a cross-sectional front view showing a configuration in which a gas storage space is ensured by a recess (core-die gas storage recess) formed on an inside bottom surface of a bushing storage recess of a core-die main body and a recess (bushing back side recess) formed on a bushing back surface.

FIG. 18 is a state where a bushing is provided in a core die and is a plan view showing an example of a configuration in which a divided bushing formed of a plurality of bushings is accommodated in a bushing storage recess of a core-die main body.

FIG. 19 is a view showing another embodiment of a projected-portion molding recess of a core die and is a plan view showing an example of a projected-portion molding recess extending from a core-die main body over a bushing accommodated in a bushing storage recess of a core-die main body.

FIG. 20 is a cross-sectional front view showing an example of a configuration in which a bushing that is formed of a porous member and has an aeration property is accommodated in a bushing storage recess of a core-die main body.

FIG. 21 is a cross-sectional front view showing another example of a configuration in which a bushing that is formed of a porous member and has an aeration property is accommodated in a bushing storage recess of a core-die main body.

FIG. 22 is a view showing a photograph obtained by capturing an image of a back surface side (opposite side of a design surface) of the resin molded product that was molded by use of a non-ventilation pass die and was manufactured as a prototype.

FIG. 23 is a view showing a photograph obtained by capturing an image of a design surface of the resin molded product of FIG. 22.

FIG. 24 is a view showing a photograph obtained by capturing an image of a back surface side (opposite side of a design surface) of the resin molded product that was molded by use of a die in which a ventilation pass is present and was manufactured as a prototype.

FIG. 25 is a view showing a photograph obtained by capturing an image of a design surface of the resin molded product of FIG. 24.

### EMBODIMENTS FOR CARRYING OUT THE INVENTION

Hereinafter, an injection molding die according to the embodiment of the invention will be described with reference to drawings.

### First Embodiment

Firstly, an injection molding die 10 according to a first embodiment of the invention will be described.

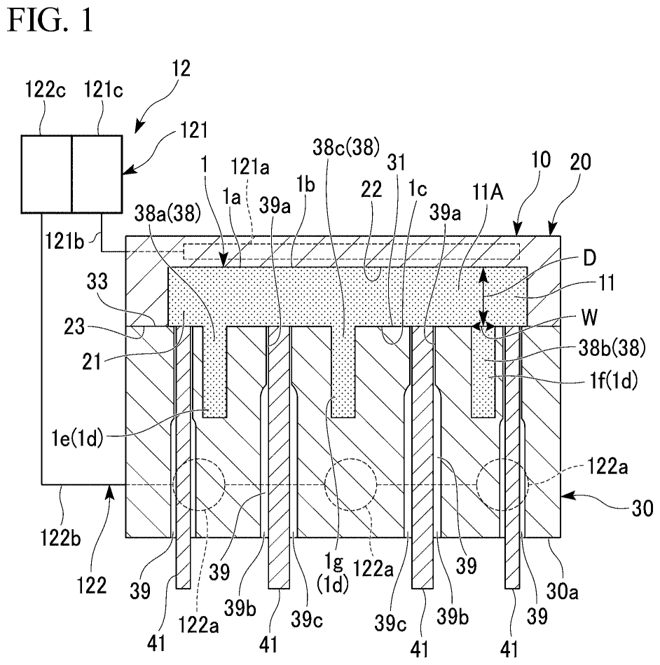

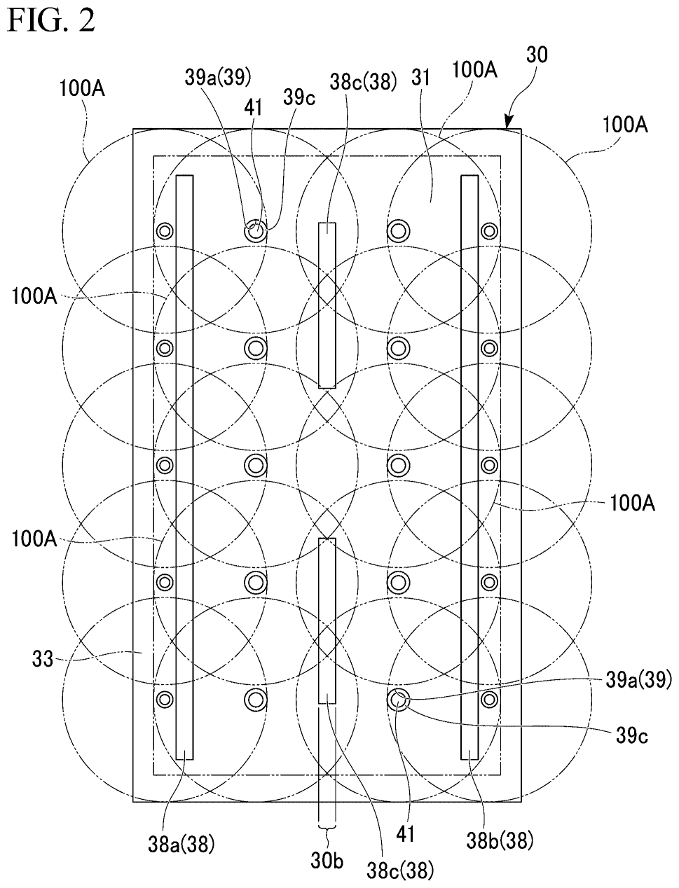

FIG. 1 is a cross-sectional front view showing the injection molding die 10 according to the aforementioned embodiment, and FIG. 2 is a view showing a core die 30 of the injection molding die 10 of FIG. 1 and is a plan view showing a configuration thereof when viewed from a back side molding surface 31 of the core die 30.

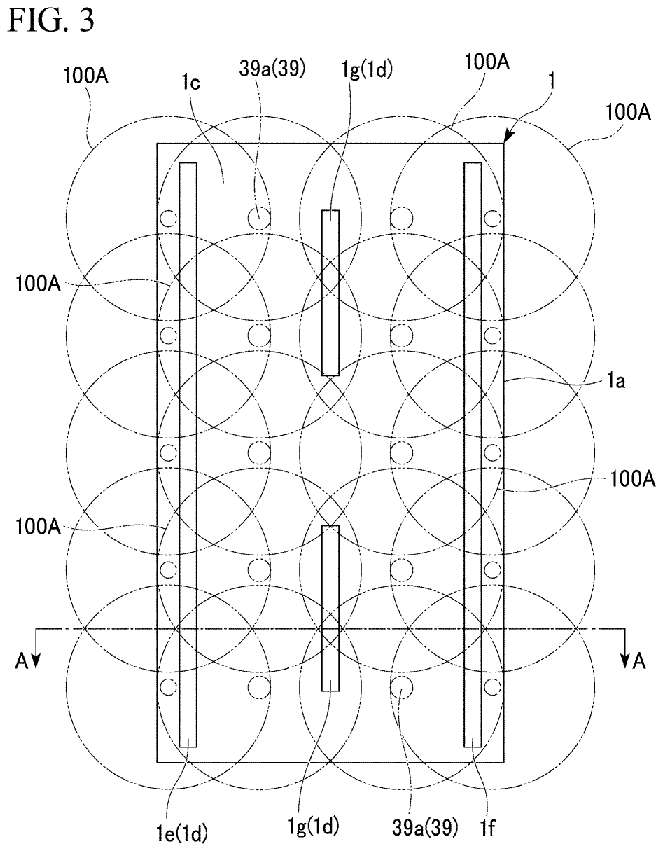

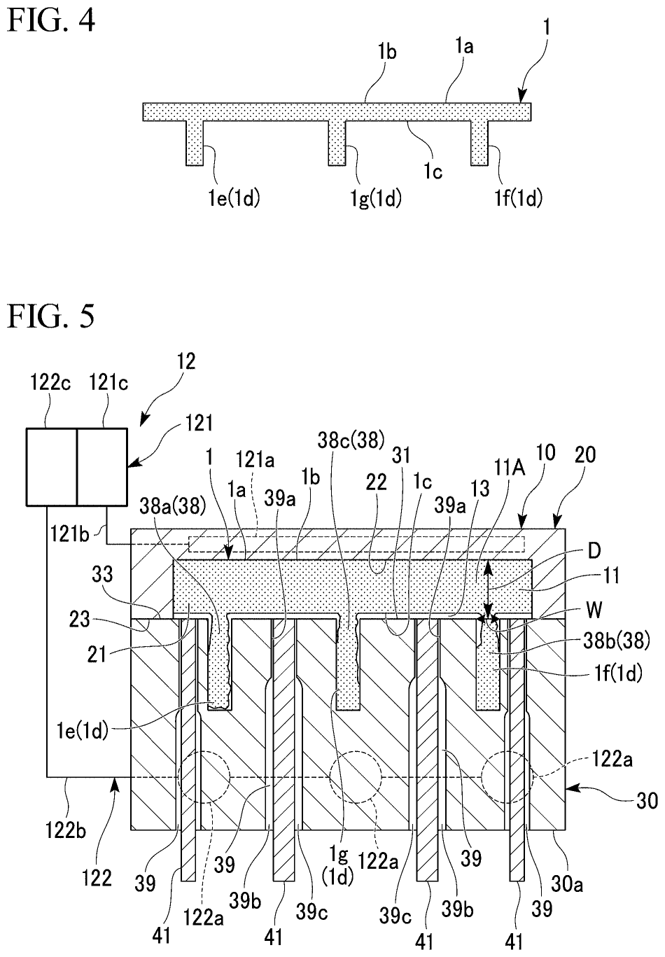

Additionally, FIG. 3 is a view showing a resin molded product 1 (hereinbelow, simply referred to as a molded product) to be molded and manufactured by use of the injection molding die 10 of FIG. 1 and is a view showing a configuration thereof when viewed from a back surface side 1c of the molded product 1, and FIG. 4 is a cross-sectional front view (a view taken along the line A-A shown in FIG. 3) showing the molded product 1 of FIG. 3.

As shown in FIG. 1, the injection molding die 10 includes: a cavity die 20; and the core die 30 that exists to be openable and closable with respect to the cavity die 20 and forms a cavity 11 between the cavity die 20 and the core die when the core die is closed and coupled to the cavity die 20.

The injection molding die 10 shown in FIG. 1 is used in a molding method of obtaining a plate-shaped molded-product main body 1a and the resin molded product 1 including projected portions 1d protruding from the back surface 1c that is on the opposite side of a design surface 1b on one surface of the molded-product main body 1a.

A molding recess 21 is formed on the cavity die 20 to mold the molded-product main body 1a of the resin molded product 1.

A molding surface 31 (a back side molding surface, also referred to as a main-body back side molding surface in the description) is formed on the core die 30 to mold the back surface side 1c that is on the opposite side of the design surface 1b of the molded-product main body 1a.

The design surface 1b (hereinbelow, also referred to as a design surface of the molded product) of the resin molded product 1 is formed by an inside bottom surface 22 of the molding recess 21 of the cavity die 20. Hereinbelow, the inside bottom surface 22 of the molding recess 21 of the cavity die 20 is also referred to as a design-surface molding surface.

FIG. 1 shows a mold clamping state in which the core die 30 is closed and coupled to the cavity die 20. Moreover, FIG. 1 shows a state where the resin molded product 1 exists in the cavity 11 serving as a space for resin molding which is ensured between the cavity die 20 and the core die 30 which are closed and coupled to each other. The resin molded product 1 is formed by solidification of the molten resin that is injected and filled to the inside of the cavity 11 from a gate of the injection molding die 10 which is not shown in the drawings.

As a resin used to form the resin molded product 1, a polyolefin resin, a polystyrene resin, an ABS resin, a polycarbonate resin, a polyamide resin, or the like may be adopted.

The injection molding die 10 includes a temperature regulation mechanism 12 that maintains the temperature of the design-surface molding surface 22 of the cavity die 20 during molding to be substantially the same as the temperature of the portion that is located at the core die 30 of the inner surface of the cavity 11.

The temperature regulation mechanism 12 maintains the temperature of the design-surface molding surface 22 of the cavity die 20 during molding to be higher than or equal to a deformation temperature of the resin to be molded. The injection molding die 10 causes the temperature of the design-surface molding surface 22 of the cavity die 20 during molding to be higher than or equal to a deformation temperature of the resin to be molded (the temperature of the inner surface of the cavity 11 located in the core die 30 is also substantially the same as the temperature of the design-surface molding surface 22). Therefore, it is possible to use the injection molding die in a molding method of bringing the design surface 1b of the resin molded product 1 during molding into close contact with the design-surface molding surface 22 of the cavity die 20.

Note that, injection molding dies according to various embodiments of the invention are common to each other in that they are available to the molding method of bringing the design surface of the resin molded product during molding into close contact with the design-surface molding surface of the cavity die by setting the temperature of the design-surface molding surface of the cavity die during molding to be higher than or equal to a deformation temperature of the resin to be molded.

The temperature regulation mechanism 12 of the injection molding die 10 shown in FIG. 1 includes: a cavity die heating mechanism 121 that heats the cavity die 20; and a core die heating mechanism 122 that heats the core die 30. The cavity die heating mechanism 121 includes: a heating pipe 121a that is attached to the cavity die 20; a fluid heating feeding portion 121c that supplies heating fluid such as hot liquid, oil, or the like to the heating pipe 121a via a connection pipe 121b; and a returning pipe which is not shown in the drawings and causes the heating fluid returning from the heating pipe 121a to the fluid heating feeding portion 121c to flow therethrough. The core die heating mechanism 122 includes: a heating pipe 122a that is attached to the core die 30; a fluid heating feeding portion 122c that supplies heating fluid such as hot liquid, oil, or the like to the heating pipe 122a via a connection pipe 122b; and a returning pipe which is not shown in the drawings and causes the heating fluid returning from the heating pipe 122a to the fluid heating feeding portion 122c to flow therethrough.

The temperature regulation mechanism 12 supplies the heating fluid heated by the fluid heating feeding portions 121c and 122c to the heating pipes 121a and 122a, heats the heating pipes 121a and 122a, transmits heat of heating fluid to the cavity die 20 and the core die 30 via the heating pipes 121a and 122a, and therefore heats the cavity die 20 and the core die 30.

The temperature regulation mechanism 12 includes a controller that controls both the fluid heating feeding portion 121c of the cavity die heating mechanism 121 and the fluid heating feeding portion 122c of the core die heating mechanism 122 and therefore adjusts a heating temperature of fluid of each of the fluid heating feeding portions 121c and 122c. The temperature regulation mechanism 12 supplies the heating fluid that was heated to have substantially the same temperature to the heating pipes 121a and 122a from, for example, the fluid heating feeding portions 121c and 122c, and maintains the temperature of the design-surface molding surface 22 of the cavity die 20 to be substantially the same as the temperature of the portion that is located on the core die 30 on the inner surface of the cavity 11.

Note that, the temperature regulation mechanism 12 is only necessary to heat the cavity die 20 and the core die 30 when resin molding in the cavity 11 and to be able to stabilize the temperature of the inner surface of the cavity 11 in both the cavi die and the core die, and the specific configuration thereof can be appropriately modified.

A parting surface 33 at the periphery of the main-body back side molding surface 31 of the core die 30 is closed and coupled to a parting surface 23 at the periphery of an opening portion of the molding recess 21 of the cavity die 20, an opening portion of the molding recess 21 is closed by the core die 30, and therefore the cavity 11 of the injection molding die 10 shown in FIG. 1 is ensured.

The core die 30 is closed and coupled to the cavity die 20 such that the parting surface 33 overlaps the parting surface 23 of the cavity die 20.

The parting surface 23 of the cavity die 20 is formed to surround the opening portion of the molding recess 21.

As shown in FIG. 1, the main-body back side molding surface 31 of the core die 30 is a surface of the core die 30 that is closed and coupled to the cavity die 20 which face the cavity 11 and is a surface facing the molding recess 21. As shown in FIG. 2, the parting surface 33 of the core die 30 is formed to surround the main-body back side molding surface 31 so as to correspond to the parting surface 23 of the cavity die 20.

Note that, the main-body back side molding surface 31 of the core die 30 shown in FIGS. 1 and 2 is a flat surface continuous to the parting surface 33 of the core die 30.

However, a part or entire of the main-body back side molding surface 31 of the core die 30 may have a shape that protrudes toward the molding recess 21 of the cavity die 20 so as to enter the inside of the molding recess 21 of the cavity die 20 when mold-clamping.

Each of the cavity die 20 and the core die 30 is a member made of a metal.

As shown in FIGS. 1 and 2, projected-portion molding recesses 38 that are depressed from the main-body back side molding surface 31 and ejector pin holes 39 are formed in the core die 30.

As shown in FIG. 1, the cavity 11 is configured of a main-body molding region 11A that located at the inside surrounded by the inner surface of the molding recess 21 of the cavity die 20 and the main-body back side molding surface 31 of the core die 30 that is closed and coupled to the cavity die 20; and the projected-portion molding recesses 38 formed on the core die 30. The inner surface of the cavity 11 includes inner surfaces of the projected-portion molding recesses 38.

The injection molding die 10 cools and solidifies molten resin that is injected to the cavity 11 from a gate which is not shown in the drawings in a mold clamping state and molds the resin molded product 1 having an outer shape following the inner surface of the cavity 11. The molded-product main body 1a of the resin molded product 1 is molded by the main-body molding region 11A of the cavity 11. The projected portions 1d (hereinbelow, also referred to as a molded-product projected portion) of the resin molded product 1 are molded by the projected-portion molding recesses 38 formed on the core die 30.

The projected-portion molding recesses 38 formed on the core die 30 function as projected-portion molding regions that mold the molded-product projected portions 1d.

The molded-product projected portions 1d shown in FIGS. 3 and 4 are each a rib that protrudes from the back surface 1c (hereinbelow, also referred to as a molded-product-main-body back surface) of the molded-product main body 1a. Hereinbelow, the molded-product projected portion 1d is also referred to as a rib. The projected portions 1d are formed at a plurality of portions on the back surface 1c of the molded-product main body 1a. Furthermore, each projected portion 1d (rib) of the resin molded product 1 shown in FIGS. 3 and 4 is formed in a protruding shape (a plate shape in FIGS. 3 and 4) such that the protruding end points (protruding ends) thereof from the molded-product main body 1a extend parallel to each other.

Regarding the molded-product main body 1a of the resin molded product 1 shown in FIGS. 3 and 4, hereinbelow, the extending direction of each rib 1d is also referred to as an extending direction of the main body, and a direction perpendicular to the extending direction of the molded-product-main-body back surface 1c is also referred to as a width direction. Hereinbelow, a width direction of the molded-product main body 1a is also referred to as a width direction of the main body.

The extending direction of the main body is the vertical direction of FIG. 3 and is the paperface depth direction of FIG. 4.

The width direction of the main body is the horizontal direction of FIG. 3 and is the horizontal direction of FIG. 4.

The ribs 1d of the resin molded product 1 shown in FIGS. 3 and 4 are formed at the three points in the width direction of the main body of the molded-product-main-body back surface 1c.

Particularly, as shown in FIG. 3, the ribs 1d formed on the resin molded product 1 are: two side ribs 1e and 1f (a first side rib 1e and a second side rib 1f) which are formed so as to extend parallel to each other and are separated from each other in the width direction of the main body of the molded-product-main-body back surface 1c; and intermediate ribs 1g which are formed at a central portion in a direction of a gap between the two side ribs 1e and 1f (coincident with the width direction of the main body). The length of the intermediate rib 1g in the extending direction thereof is shorter than the lengths of the two side ribs 1e and 1f in the extending direction thereof. The intermediate ribs 1g are formed at a plurality of points (two points in FIG. 3) in the extending direction of the main body. The intermediate ribs 1g of the resin molded product 1 are formed and spaced apart from each other at a distance in the extending direction of the main body.

The projected-portion molding recesses 38 of the core die 30 shown in FIGS. 1 and 2 are formed on the core die 30 at a plurality of points corresponding to positions of the ribs 1d of the resin molded product 1.

Each projected-portion molding recess 38 (specifically, an inner surface thereof) is formed in a groove shape corresponding to the outer shape of the rib 1d of the resin molded product 1.

The paperface depth direction of FIG. 1 and the vertical direction of FIG. 2 correspond to the extending direction of the main body of the resin molded product 1. Hereinbelow, regarding the core die 30, the paperface depth direction of FIG. 1 and the vertical direction of FIG. 2 are also referred to as an extending direction.

Furthermore, the horizontal direction of FIG. 1 and the horizontal direction of FIG. 2 correspond to the width direction of the main body of the resin molded product 1.

Hereinbelow, regarding the core die 30, the horizontal direction of FIG. 1 and the horizontal direction of FIG. 2 are also referred to as a width direction.

Regarding the injection molding die 10, the cavity die 20, and the core die 30 which are in a mold clamping state, hereinbelow, the vertical direction of FIG. 1, that is, the direction of the gap between the design-surface molding surface 22 and the main-body back side molding surface 31 which face each other via the cavity 11 when the injection molding die 10 is in a mold clamping state is also referred to as a height direction. A height direction of the core die 30 coincides with a direction of a pressing force pressing the core die 30 against the cavity die 20 when mold-clamping the injection molding die 10.

The projected-portion molding recesses 38 of the core die 30 shown in FIGS. 1 and 2 are formed at three points in the width direction of the core die 30 and are each formed in a groove shape extending in the extending direction of the core die 30.

A first side recess 38a serving as the projected-portion molding recess 38 that is used to mold the first side rib 1e of the resin molded product 1, a second side recess 38b serving as the projected-portion molding recess 38 that is used to mold the second side rib 1f, and intermediate recesses 38c serving as the projected-portion molding recesses 38 that are used to mold the intermediate ribs 1g are formed on the core die 30 shown in FIGS. 1 and 2. The intermediate recesses 38c are formed at the central portion between the first side recess 38a and the second side recess 38b in the width direction of the core die 30.

The ejector pin holes 39 are formed on the core die 30 so as to penetrate from the main-body back side molding surface 31 to a bottom surface 30a (bottom surface of the core die) of the core die 30 on the opposite side of the main-body back side molding surface 31.

Ejector pins 41 that remove the resin molded product 1 from the core die 230 of the injection molding die 10 in mold release after completion of molding the resin molded product 1 are inserted into the ejector pin holes 39. The injection molding die 1 includes the ejector pins 41.

As shown in FIG. 1, the ejector pin holes 39 each include: a pin guide hole 39a that extends from the main-body back side molding surface 31 toward the core-die bottom surface 30a; and a large-diameter hole 39b that is formed to have a diameter larger than that of the pin guide hole 39a and extends from the pin guide hole 39a to the bottom surface side 30a of the core die.

Due to driving of a pin movement device which is not shown in the drawings, the ejector pins 41 can switch between a standby position (position shown in FIG. 1) at which the end portions accommodated in the pin guide holes 39a do not protrude from the pin guide holes 39a toward the cavity die 20 and a protruding position at which the end portions protrude from the pin guide holes 39a toward the cavity die 20.

As the ejector pins 41, a pin is adopted in which an outer diameter of the entirety of a part (end portion) accommodated in the pin guide hole 39a is smaller than an internal diameter of the pin guide hole 39a by approximately 0.02 mm (0.01 to 0.03 mm).

A gap 39c that is ensured between an inner surface of the ejector pin hole 39 and the ejector pin 41 located inside the ejector pin hole 39 functions as a ventilation pass that connects the cavity 11 of the injection molding die 10 in a mold clamping state and an external space of the core die 30 such that ventilation is possible.

Hereinbelow, the gap 39c between the inner surface of the ejector pin hole 39 and the ejector pin 41 inside the ejector pin hole 39 is also referred to as a pin-hole ventilation pass.

The ejector pin holes 39 have function of ensuring the pin-hole ventilation pass 39c in the core die 30.

Note that, the outer-periphery of a molding-surface side opening portion that opens at the main-body back side molding surface 31 of the pin-hole ventilation pass 39c is substantially the same as the outer-periphery of a molding-surface side opening portion that opens at the main-body back side molding surface 31 of the ejector pin hole 39.

In the description, not only the pin-hole ventilation passes 39c but also the ejector pin holes 39 are referred to as a ventilation pass that connects the cavity 11 of the injection molding die 10 in a mold clamping state and the external space of the core die 30 such that ventilation is possible.

Since the portion of the pin-hole ventilation pass 39c which is between the inner surface of the pin guide hole 39a of the ejector pin hole 39 and the end portion of the ejector pin 41 at the standby position is an extremely narrow space, molten resin that is injected and supplied to the cavity 11 does not enter the space. Alternatively, even where entering of molten resin occurs, an amount of the molten resin is extremely slight. The pin-hole ventilation passes 39c each have a configuration in which entering of molten resin from the cavity 11 substantially does not occur.

The molding of the resin molded product 1 by use of the injection molding die 10 is achieved by filling the inside of the cavity 11 of the injection molding die 10 in a mold clamping state with the molten resin by injection thereof thereafter cooling and solidifying the molten resin inside the cavity 11. When the injection molding die 10 is in a mold clamping state, the ejector pins 41 are disposed at the standby position.

The resin molded product 1 molded by cooling and solidifying the molten resin inside the cavity 11 is demolded from the cavity die 20 by mold-opening of the injection molding die 10. Next, the resin molded product 1 is pressed by the ejector pins 41 that moves from the standby position to the protruding position with respect to the core die 30 by driving the pin movement device and is thereby removed (demolded) from the core die 30.

In the injection molding die 10, the gas present in the cavity 11 (air, discharged gas from molten resin, or the like) can be discharged from the cavity 11 to the outside of the injection molding die 10 (outer surface side of the core die 30) through the ejector pin holes 39 (particularly, the aforementioned pin-hole ventilation passes 39c) in accordance with progress of filling of the inside of the cavity 11 with the molten resin in a mold clamping state.

Furthermore, in the injection molding die 10 which is in a mold clamping state, when reduction in volume of the resin molded product 1 molded inside the cavity 11 occurs due to lowering of the temperature thereof, it is possible to cause air to enter between the molded-product-main-body back surface 1c and the main-body back side molding surface 31 of the core die 30 from the outside of the injection molding die 10 (outer surface side of the core die 30) through the ejector pin holes 39 (particularly, the aforementioned pin-hole ventilation passes 39c).

Note that, “outer surface of the core die 30” means an external surface that is exposed without being covered with the cavity die 20 of the core die 30 in the injection molding die 10 which is in a mold clamping state.

As shown in FIG. 1, the ends of the ejector pin holes 39 of the core die 30 in the extending direction and the other ends thereof in the extending direction open at the main-body back side molding surface 31 and the core-die bottom surface 30a, respectively. The core-die bottom surface 30a is part of the outer surface of the core die 30.

Hereinbelow, an opening portion of the ejector pin hole 39 which opens at the main-body back side molding surface 31 is referred to as a molding-surface side opening portion, and an opening portion which opens at the core-die bottom surface 30a is referred to as a core-die-outer-surface opening portion.

The gas that is present in the cavity 11 and is to be discharged to the outside of the injection molding die 10 (outer surface side of the core die 30) through the ejector pin holes 39 when injecting and filling of the molten resin to the inside of the cavity 11 is specifically discharged from the core-die-outer-surface opening portions of the ejector pin holes 39 to the outside of the core die 30. When reduction in volume of the resin molded product 1 molded inside the cavity 11 occurs due to lowering of the temperature thereof, air present at the bottom surface side 30a of the core die 30 specifically enters between the molded-product-main-body back surface 1c and the main-body back side molding surface 31 of the core die 30 through the ejector pin holes 39.

Hereinbelow, the region at which the intermediate recesses 38c at the central portion between the first side recess 38a and the second side recess 38b in the width direction of the main-body back side molding surface 31 of the core die 30 shown in FIG. 2 are located are also referred to as an intermediate-recess formation region 30b.

As shown in FIG. 2, the ejector pin holes 39 are formed at a plurality of portions of the core die 30. A plurality of the ejector pin holes 39 are formed such that a plurality of the molding-surface side opening portions are located at each of the region between first side recess 38a and the intermediate-recess formation region 30b of the main-body back side molding surface 31 of the core die 30 and the region between the second side recess 38b and the intermediate-recess formation region 30b.

Additionally, the ejector pin holes 39 having the molding-surface side opening portions that are located in the region between the parting surface 33 of the core die 30 and the first side recess 38a, and the ejector pin holes 39 having the molding-surface side opening portions that are located in the region between the parting surface 33 of the core die 30 and the second side recess 38b, are also formed on the core die 30.

In FIGS. 1 and 2, the ejector pin holes 39 having the molding-surface side opening portions that are located in the region between the parting surface 33 of the core die 30 and the first side recess 38a, and the ejector pin holes 39 having the molding-surface side opening portions that are located in the region between the parting surface 33 of the core die 30 and the second side recess 38b, are each formed so as to have diameters that are smaller than those of the ejector pin holes 39 opening at the region between the first side recess 38a and the intermediate-recess formation region 30b and the ejector pin holes 39 opening at the region between the second side recess 38b and the intermediate-recess formation region 30b.

However, internal diameters of the ejector pin holes 39 are suitably set in a size range in which the pin-hole ventilation pass 39c can be ensured. Regarding the internal diameters of the ejector pin holes 39, those of all ejector pin holes 39 of the core die 30 may be the same as each other or the ejector pin holes 39 of the core die 30 may have three or more kinds of internal diameters.

The cavity die 20 does not have a gas entering path that is used to cause gas to enter a portion between the design surface 1b of the resin molded product 1 and the design-surface molding surface 22 of the cavity die 20.

On the other hand, since a portion between the molded-product-main-body back surface 1c and the main-body back side molding surface 31 of the core die 30 allows air to enter thereto from the outside of the injection molding die 10 at the molded-product-main-body back surface side 1c of the resin molded product 1 through the ejector pin holes 39, sink is easily generated as compared with the design surface side 1b of the resin molded product 1.

The temperature of the design-surface molding surface 22 of the cavity die 20 is maintained substantially the same as the temperature of the main-body back side molding surface 31 of the core die 30 (however, the temperature higher than or equal to a deformation temperature of resign to be molded) by the temperature regulation mechanism 12. Consequently, cooling of the resin material (resin used to form the resin molded product 1) progresses during molding in a state where both the design-surface molding surface 22 of the cavity die 20 and the main-body back side molding surface 31 of the core die 30 are maintained to be in close contact with each other. In this process, when the volume of the resin becomes lower than the volume of the cavity 11, gas enters only the molded-product-main-body back surface side 1c through the ejector pin holes 39. Due to the entering of the gas, the portions close to the back surface 1c of the molded-product main body 1a is not restrained by the core die 30 but can cause sink to be freely generated thereat. As a result, in the molding of the resin molded product 1 by use of the injection molding die 10, as shown in FIG. 5, the sink that is generated by reduction in volume of the resin molded product 1 in accordance with lowering of the temperature of the resin molded product 1 molded inside the cavity 11 can be concentrated to the molded-product-main-body back surface side 1c.

Moreover, as shown in FIG. 2, in the injection molding die 10, by adjustment of the number of ejector pin holes 39 of the core die 30 formed therein and positions of the molding-surface side opening portions on the main-body back side molding surface 31, the entirety of the main-body back side molding surface 31 is located in a range of 100 mm which is a shortest distance from the molding-surface side opening portion of the ejector pin hole 39 along the main-body back side molding surface 31. A distance from the molding-surface side opening portion of the ejector pin hole 39 along the main-body back side molding surface 31 is 100 mm in shortest distance (distance is 100 mm on the main-body back side molding surface 31). Hereinbelow, the distance range is also referred to as a 100-mm-shortest-distance range.

The shortest distance from the molding-surface side opening portion of the ejector pin hole 39 along the main-body back side molding surface 31 means the distance from the molding-surface side opening portion of the ejector pin hole 39 in the shortest route that avoids the projected-portion molding recesses on the main-body back side molding surface 31. The shortest distance from the molding-surface side opening portion of the ejector pin hole 39 on the main-body back side molding surface 31 is in a range of 100 mm. Regarding the distance range, in the case where an opening portion of the projected-portion molding recess is present in range of less than 100 mm from the molding-surface side opening portion of the ejector pin hole 39 on the main-body back side molding surface 31, the aforementioned distance range means a range in which an extension length from the molding-surface side opening portion of the ejector pin hole 39 in the shortest circumvention route on the main-body back side molding surface 31 which avoids the opening portion of the projected-portion molding recess 38 is 100 mm.

FIGS. 1 and 2 show an example case where the entirety of the main-body back side molding surface 31 of the core die 30 is a flat surface extending in the horizontal direction perpendicular to the height direction of the core die 30.

As shown in FIG. 2, in the core die 30 of the injection molding die 10, a configuration is adopted in which the entire region of the main-body back side molding surface 31 including all of the projected-portion molding recesses 38 is located in the range of 100 mm from each molding-surface side opening portion of the ejector pin hole 39 on the main-body back side molding surface 31. Hereinbelow, the range of 100 mm from the molding-surface side opening portion of the ejector pin hole 39 on the main-body back side molding surface 31 is also referred to as a projected-portion-molding-setting region 100A.

In the case where the entirety of the main-body back side molding surface 31 of the core die 30 is a flat surface extending in the horizontal direction of the core die 30, the projected-portion-molding-setting region 100A coincides with the range of 100 mm from the molding-surface side opening portion of the ejector pin hole 39 in the horizontal direction of the core die 30.

However, a configuration may also be adopted in which the main-body back side molding surface 31 of the core die 30 has a portion (including a curved portion) that is inclined with respect to the horizontal direction of the core die 30. The projected-portion-molding-setting region 100A including an inclined portion with respect to the horizontal direction of the core die 30 on the main-body back side molding surface 31 is a region that is narrower than the range of 100 mm from the molding-surface side opening portion of the ejector pin hole 39 when seen in a plan view of the core die 30.

Note that, in other words, the range of 100 mm from the molding-surface side opening portion of the ejector pin hole 39 when seen in a plan view of the core die 30 is a projected range obtained by projecting the range of 100 mm from the molding-surface side opening portion of the ejector pin hole 39 in the horizontal direction of the core die 30 to the main-body back side molding surface 31 in the height direction of the core die 30.

The ejector pin hole 39 is an example of the ventilation pass that opens at the main-body back side molding surface and connects the cavity and a space outside the injection molding die such that ventilation is possible.

In FIG. 2, all of the projected-portion molding recesses 38 of the entirety of the core die 30 are located inside the projected-portion-molding-setting region 100A with respect to the ejector pin hole 39 (ventilation pass).

The inventor verified that, in the case where a ventilation pass such as an ejector pin hole or the like is present in the core die of the injection molding die, a region in which air can enter a portion between the molded-product-main-body back surface and the core die main-body back side molding surface through the ventilation pass by reduction in volume of the resin molded product molded inside the cavity due to lowering of the temperature thereof.

As a result, the inventor understood that the projected-portion molding recesses 38 located inside the projected-portion-molding-setting region 100A can cause air to enter the all portion between the inner surface thereof and the molded-product projected portions 1d in the projected-portion molding recesses 38 through the ventilation pass.

A gap 13 (refer to FIG. 5, hereinbelow, referred to as a sink portion gap) is formed between the molded-product-main-body back surface 1c and the main-body back side molding surface 31 by sink on the molded-product-main-body back surface.

The entering of air into a portion between the inner surfaces of the projected-portion molding recesses 38 and the molded-product projected portions 1d inside the projected-portion molding recesses 38 through the ventilation pass is achieved by passing through the sink portion gap 13 between the molded-product-main-body back surface and the main-body back side molding surface.

As mentioned above, air passes through between the molded-product-main-body back surface 1c and the main-body back side molding surface 31 through the ventilation pass and thereby can enter a portion between the inner surfaces of the projected-portion molding recesses 38 located inside the projected-portion-molding-setting region 100A and the molded-product projected portions 1d located thereinside. Consequently, a degree of flexibility in generation of sink at the molded-product-main-body back surface 1c and the projected portion 1d of the resin molded product 1 increases. As a result, even in the case where molding is carried out such that the temperature of the design-surface molding surface 22 of the cavity die 20 is substantially the same as the temperature of the main-body back side molding surface 31 of the core die 30, the sink that is caused by reduction in volume along with cooling can be concentrated to the molded-product projected portion 1d, sink can be prevented from being generated at the portions of the design surface 1b of the molded product which correspond to the molded-product projected portions 1d, and warpage of the molded product can also be prevented from being generated.

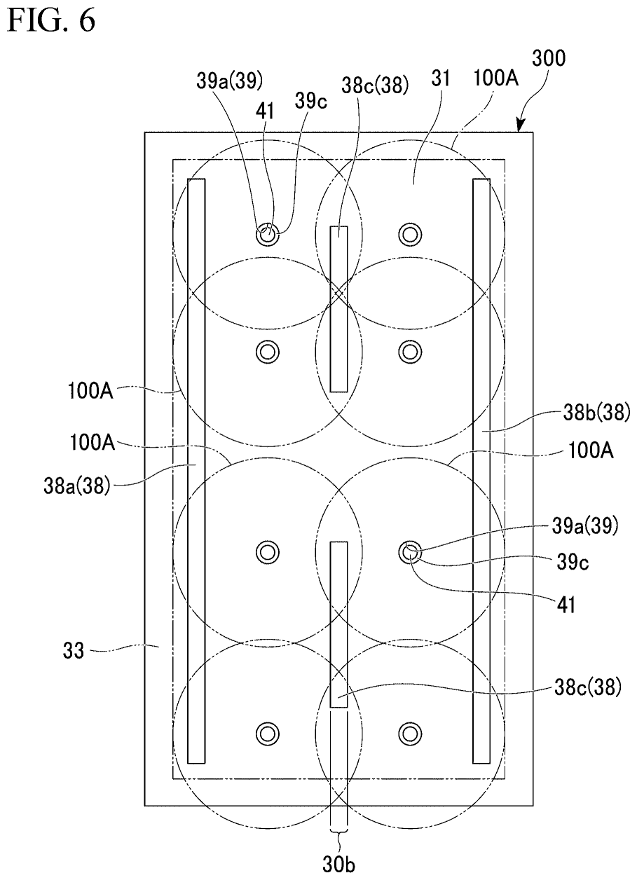

FIG. 6 is a plan view showing a core die of Comparative Example 300.

In the core die 30 shown in FIG. 6, the number of and positions of ejector pin holes 39 of the core die 30 to be formed which are shown in FIGS. 1 and 2 are changed. The configuration other than the number of and positions of ejector pin holes 39 of the core die 30 to be formed which are shown in FIG. 6 is the same as that of FIGS. 1 and 2.

In FIG. 6, common reference numerals are used for the elements which are identical to those of FIGS. 1 and 2, and the explanations thereof are omitted or simplified here.

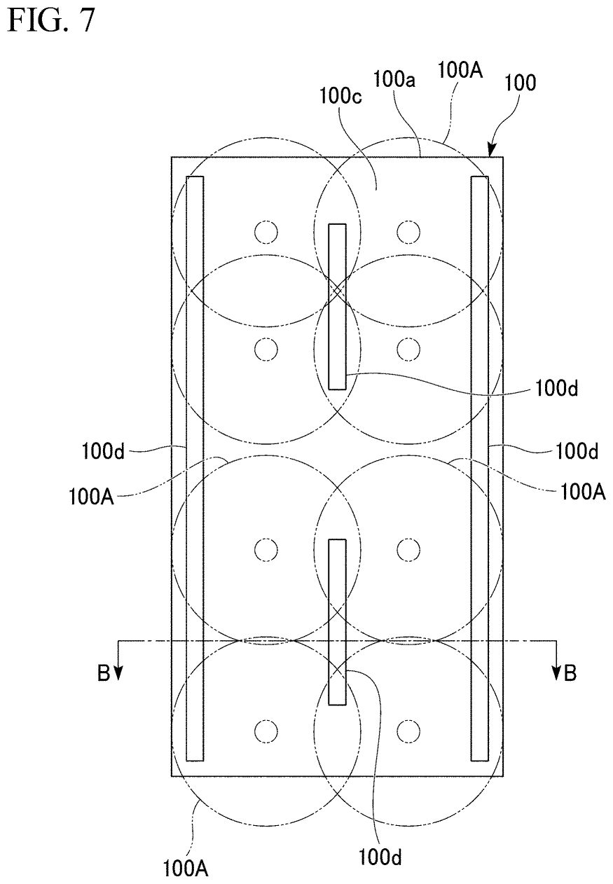

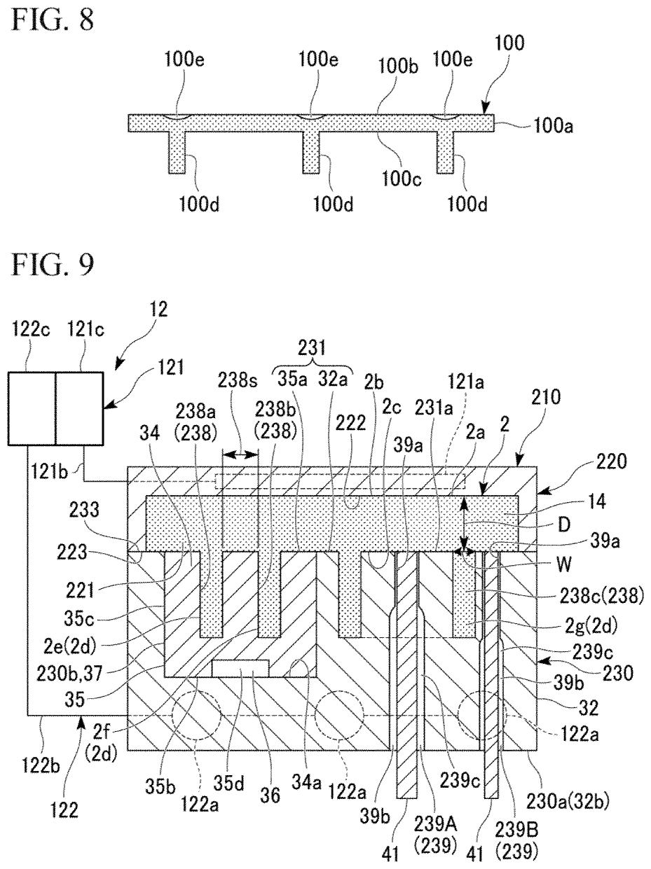

FIG. 7 is a view showing a view showing a resin molded product 100 molded by use of the injection molding die that is obtained by changing the core die 30 of the injection molding die 10 of FIG. 1 to the core die 300 shown in FIG. 6 and is a view showing a configuration when viewed from a back surface side of the resin molded product 100. FIG. 8 is a view taken along the cross section line shown by arrow B-B of FIG. 7.

Note that, the projected-portion-molding-setting region 100A corresponding to each of opening portions of the ejector pin holes 39 of the core die 300 shown in FIG. 6 is shown in FIG. 7.

The opening portions of the ejector pin holes 39 are present on the main-body back side molding surface 31 of the core die 300 shown in FIG. 6. However, on the main-body back side molding surface 31 and the projected-portion molding recesses 38 of the core die 300 shown in FIG. 6, there is a portion which is not included in each of the projected-portion-molding-setting regions 100A of the core die 300.

The B-B line shown in FIG. 7 passes through a portion that was molded at the outside of the projected-portion-molding-setting region 100A of the core die 300 shown in FIG. 6 on the rib 1d of the resin molded product 100.

The injection molding die that adopts the core die 300 shown in FIG. 6 can mold the resin molded product 100 having the configuration that is the same as the resin molded product 1 molded by use of the injection molding die 10 of FIG. 1.

As shown in FIGS. 7 and 8, the resin molded product 100 molded by use of the injection molding die that adopts the core die 300 shown in FIG. 6 includes a plate-shaped molded-product main body 100a and ribs 100d protruding from a back surface 100c on the opposite side of a design surface 100b of one surface of the molded-product main body 100a. However, as shown in FIG. 8, on the resin molded product 100, sink portions 100e (recesses) easily occur at positions of the design surface 100b of the molded-product main body 100a which correspond to the ribs 100d.

The entirety of each of the all rib 1d of the resin molded product 1 molded by use of the injection molding die 10 shown in FIG. 1 is molded inside the projected-portion-molding-setting region 100A of the core die 30.

As shown in FIG. 4, the resin molded product 1 molded by use of the injection molding die 10 of FIG. 1 can prevent sink from being generated at the positions of the design surface 1b of the molded-product main body 1a which correspond to the ribs 1d. The injection molding die 10 of FIG. 1 can prevent sink from being generated on the entire design surface 1b of the resin molded product 1, and it is possible to stably obtain the design surface 1b having an excellent external appearance.

Note that, in FIG. 4, sink formed on the rib 1d is not shown in the drawings.

As shown in FIG. 2, the intermediate recesses 38c of the injection molding die 10 are located inside the projected-portion-molding-setting regions 100A, that is, inside the projected-portion-molding-setting regions 100A with respect to the molding-surface side opening portion of the ejector pin hole 39 located between the intermediate-recess formation region 30b and the first side recess 38a, and inside the projected-portion-molding-setting regions 100A with respect to the molding-surface side opening portion of the ejector pin hole 39 located between the intermediate-recess formation region 30b and the second side recess 38b.

In the injection molding die 10 shown in FIGS. 1 and 2, it is possible to cause air to enter the portions between the intermediate ribs 1g of the resin molded product 1 and the inner surfaces of the intermediate recesses 38c from the molding-surface side opening portions of the ejector pin holes 39 on both sides in the width direction of the core die 30 through the intermediate-recess formation region 30b of the main-body back side molding surface 31 of the core die 30. Air can enter the portions between the intermediate ribs 1g of the resin molded product 1 and the inner surfaces of the intermediate recesses 38c from both sides in the thickness direction of the intermediate rib 1g.

In the projected-portion-molding-setting region 100A, between the molded-product-main-body back surface 1c of the resin molded product 1 and the main-body back side molding surface 31 of the core die 30, it is possible to form the sink portion gap 13 that reaches the projected-portion molding recesses 38 from the molding-surface side opening portions of the ejector pin holes 39. In the projected-portion-molding-setting region 100A, the entering of air from the ejector pin holes 39 to the portions between the inner surfaces of the projected-portion molding recesses 38 and the ribs 1d located thereinside can be realized via the sink portion gap 13 that reaches the projected-portion molding recesses 38 from the molding-surface side opening portion of the ejector pin hole 39.

The inventor found out that, although air enters from outside to a portion between the main-body back side molding surface 31 of the core die 30 and the molded-product-main-body back surface 1c through the ejector pin holes 39, practically, the entering of air from the parting surface mostly does not occur. Because of this, in the case where the molding-surface side opening portions of the projected-portion molding recesses 38 exist on the main-body back side molding surface 31 of the core die 30, it is preferable that the ejector pin holes 39 be arranged at both sides of the molding-surface side opening portion of the projected-portion molding recess 38 so as to interpose the recess therebetween. However, the sink portion gap 13 that reaches the projected-portion molding recesses 38 from the molding-surface side opening portion of the ejector pin hole 39, at the middle of the sink portion gap 13 means a portion that is formed by a route not having the rib 1d of the resin molded product 1.

Here, a case will be described where the number of molding-surface side opening portion of the ejector pin hole 39 that exists on the main-body back side molding surface 31 of the core die 30 is temporarily only one. In this case, when the rib 1d that crosses the projected-portion-molding-setting region 100A with respect to the molding-surface side opening portion of the ejector pin hole 39 exists on the resin molded product 1 and when the projected-portion-molding-setting region 100A is separated into a region at one of the surfaces of the rib 1d on which the molding-surface side opening portion of the ejector pin hole 39 exists and a region at the other of the surfaces of the rib 1d on which the molding-surface side opening portion of the ejector pin hole 39 does not exist, the sink portion gap 13 that reaches the projected-portion molding recesses 38 from the molding-surface side opening portion of the ejector pin hole 39 is formed only on the region at one of the surfaces of the rib 1d.

For example, the first side rib 1e shown in FIG. 3 separates the projected-portion-molding-setting region 100A with respect to the ejector pin hole 39 that is located at the central portion of the core die 30 in the extending direction between the first side recess 38a (refer to FIG. 2) that molds the first side rib 1e and the intermediate-recess formation region 30b.

In the case where the ejector pin hole 39 of the core die 30 is temporarily only one ejector pin hole 39 that is located at the central portion of the core die 30 in the extending direction between the first side rib 1e and the intermediate-recess formation region 30b, the sink portion gap 13 that reaches the first side recess 38a from the ejector pin hole 39 can be reliably formed at a region close to the portion at which the ejector pin hole 39 is located near the first side rib 1e of the projected-portion-molding-setting region 100A with respect to the ejector pin hole 39. In contrast, it is difficult to form the sink portion gap 13 that passes through a region close to the portion at which the ejector pin hole 39 is not located near the first side rib 1e of the projected-portion-molding-setting region 100A and reaches the first side recess 38a from the ejector pin hole 39.

The case will be continuously described where the number of molding-surface side opening portion of the ejector pin hole 39 that exists on the main-body back side molding surface 31 of the core die 30 is temporarily only one.

In this case, a configuration of the projected-portion-molding-setting region 100A is not a configuration in which the rib 1d located inside the projected-portion-molding-setting region 100A crosses the projected-portion-molding-setting region 100A, but the projected-portion-molding-setting region 100A may be adopted which has a configuration in which a portion is present which has a region at one of the surfaces of the rib 1d on which the molding-surface side opening portion of the ejector pin hole 39 exists and a region at the other of the surfaces of the rib 1d on which the molding-surface side opening portion of the ejector pin hole 39 does not exist which are continuous to each other. It is possible to form the sink portion gap 13 that reaches the projected-portion molding recesses 38 from the molding-surface side opening portions of the ejector pin holes 39 at the region at one of the surfaces of the rib 1d of the projected-portion-molding-setting region 100A having this configuration. Furthermore, the sink portion gap 13 that reaches the projected-portion molding recesses 38 from the molding-surface side opening portions of the ejector pin holes 39 can also be formed by a route passing through the region at the other of the surfaces of the rib 1d of the projected-portion-molding-setting region 100A.

In the case of controlling the die temperatures of the cavity die 20 and the core die 30 to be substantially the same as each other, the resin molded product 1 is about to be brought into close contact with both the cavity die 20 and the core die 30. Accordingly, at the portion near the end face of the molded-product main body 1a of the resin molded product 1, in order to cause air to enter from a die parting portion to a portion between the resin molded product 1 and the cavity die 20 or the core die 30, it is necessary to pull and peel the end face of the molded-product main body 1a in a close-contact state therefrom, and a large force is required therefor.

Moreover, when filling molten resin, a high temperature resin flows to the inside of the cavity 11 while forming a skin layer. On the other hand, since the end face portions of the molded-product main body 1a of the resin molded product 1 are in contact with the die 10 in the three directions, the molten resin is in a state while being cooled while receiving a holding pressure at a pressure of filling it therewith. For this reason, at the end face portion of the molded-product main body 1a of the resin molded product 1, a degree of volume contraction along with cooling after completion of filling becomes smaller as compared with the portion (hereinbelow, also referred to as a main section) other than the portion near the end face of the periphery of the molded-product main body 1a, and a timing of separating from the inner surface of the die due to volume contraction becomes later as compared with that of the main section.

A degree of volume contraction along with cooling after completion of filling at the central portion of the molded-product main body 1a to which resin flowed at a high temperature during filling of the cavity 11 with molten resin becomes larger than that of the end face portion, as a thickness of the molded-product main body 1a becomes lower than a thickness of the cavity 11 (a size corresponding to a thickness of the molded-product main body 1a) due to volume contraction, entering of air into a portion between the main-body back side molding surface 31 and the molded-product-main-body back surface 1c through the ventilation pass such as the ejector pin hole 39 or the like which opens at the main-body back side molding surface 31 of the core die 30 is started.

As described above, in order to cause air to enter a portion between the resin molded product 1 and the cavity die 20 or the core die 30 through the die parting portion at a portion near the end face of the molded-product main body 1a, it is necessary to pull and peel the end face of the molded-product main body 1a in a close-contact state therefrom. In contrast, entering of air into a portion between the inner surface of the die (inner surface of the cavity 11) and the resin molded product 1 through the ventilation pass such as the ejector pin hole 39 or the like easily progresses. As a result, at the portion near the end face of the molded-product main body 1a, entering of air into a portion between the resin molded product 1 and the cavity die 20 or the core die 30 through the die parting portion is likely to occur.

According to the injection molding die 10 shown in FIGS. 1 and 2, it is possible to form the sink portion gap 13 that reaches the intermediate recesses 38c from each of the molding-surface side opening portions of the ejector pin holes 39 at both sides of in the width direction of the core die 30 through the intermediate recesses 38c of the core die 30. Additionally, it is possible to cause air to enter the portions between the intermediate ribs 1g of the resin molded product 1 and the inner surfaces of the intermediate recesses 38c from both sides in the thickness direction of the intermediate rib 1g. As compared with the configuration that causes air to enter the portions between the intermediate ribs 1g of the resin molded product 1 and the inner surfaces of the intermediate recesses 38c only from the molding-surface side opening portion of the ejector pin hole 39 on one side in the width direction of the core die 30 with respect to the intermediate recess 38c, according to the configuration that causes air to enter the portions between the intermediate ribs 1g of the resin molded product 1 and the inner surfaces of the intermediate recesses 38c from both sides in the thickness direction of the intermediate rib 1g, entering of air into the portions between the intermediate ribs 1g of the resin molded product 1 and the inner surfaces of the intermediate recesses 38c can be reliably and widely realized. Consequently, in the injection molding die 10 shown in FIGS. 1 and 2, it is possible to reliably ensure flexibility in sink from being generated due to lowering of the temperature of the intermediate rib 1g and realize prevention of sink from being generated due to lowering of the temperature thereof at the portions of the design surface 1b of the resin molded product 1 which correspond to the intermediate ribs 1g.

As shown in FIG. 2, the entire first side recess 38a of the core die 30 is located inside the projected-portion-molding-setting regions 100A which are from the molding-surface side opening portions of the ejector pin holes 39 that are located between the intermediate-recess formation region 30b of the main-body back side molding surface 31 of the core die 30 and the first side recess 38a. The entire second side recess 38b is located inside the projected-portion-molding-setting regions 100A which are from the molding-surface side opening portions of the ejector pin holes 39 that are located between the intermediate-recess formation region 30b of the main-body back side molding surface 31 of the core die 30 and the second side recess 38b.

Since air can enter the portions between the inner surfaces of the side ribs 1e and 1f and the first and second side recesses 38a and 38b from the ejector pin holes 39, flexibility in sink can be ensured when molding of the side ribs 1e and 1f molded by the first side recess 38a and the second side recess 38b of the core die 30. As a result, in the molding of the resin molded product 1 by use of the injection molding die 10, prevention of sink from being generated on the portions of the design surface 1b of the molded product which correspond the side ribs 1e and 1f can be reliably realized.

Hereinbelow, a portion of the design surface 1b of the resin molded product 1 which corresponds to the rib of the resin molded product 1 is also referred to as a rib correspondence portion.

According to the results of the inventor's research, a distance between the projected-portion molding recess 38 and the ejector pin hole 39 which can effectively prevent sink from being generated at the rib correspondence portions varies depending on a plate thickness, and there is a tendency that the distance is short in the case where the plate thickness is large, the distance becomes long in the case where the plate thickness is small. The reason for this is that, the thicker the plate thickness, the more an amount of shrinkage of resin increases, and that a large amount of gas is necessary. If the thickness is constant, volume contractions of the various portions of the resin molded product 1 due to cooling in a molding process progress at substantially the same time; however, entering of air that passes through the ventilation pass progresses in order toward the outside while forming the sink portion gap 13. Therefore, at the portion far from the ventilation pass, a thickness of the resin molded product 1 is smaller than a thickness of the cavity before air reaching, and sink is very likely to be generated on the design surface side. In the case where the plate thickness is in a range of 2 mm to 3 mm, a distance between the projected-portion molding recess 38 and the ejector pin hole 39 be approximately 100 mm; however, 20 mm to 50 mm is referable. As long as this range is obtained, even where the core die 30 catches resin depending on a shape of the back surface or there is a portion having a locally high cooling rate, an effect of reducing sink at the rib correspondence portions of the design surface 1b of the resin molded product 1 can be produced. In the case where a distance between the projected-portion molding recess 38 and the ejector pin hole 39 is less than or equal to 20 mm, although the effect of reducing sink at the rib correspondence portions of the design surface 1b is sufficiently obtained, the number of times of machining the ejector pin holes 39 (forming numbers) increases, and therefore it is not practical.

However, when the molten resin is injected and filled to the inside of the cavity 11 of the injection molding die 10 in a mold clamping state through a die gate, an injection pressure of the molten resin is applied to the gas present in the cavity 11 (air, discharged gas from molten resin, or the like). Part of the gas present in the cavity 11 leaks out to the outside of the die from a matching portion (hereinbelow, also referred to as a die parting portion) of the parting surfaces 23 and 33 at which the cavity 20 die and the core die 30 are in contact with each other until completion of filling of the inside of the cavity 11 with the molten resin. However, leakage of the molten resin from the parting portion does not occur.

A plurality of microscopic gas pathways that are provided with microscopic uneven portions formed on the parting surfaces 23 and 33 and can cause gas to leak out from the cavity 11 are ensured on the die parting portion. In the case where a prerequisite condition other than a mold clamping force between the cavity 20 die and the core die 30 is constant, the stronger a mold clamping force of the injection molding die 10, the lower a leakage amount of gas present in the cavity 11 from the die parting portion.

At the portion close to the die parting portion of the cavity 11 which is covered with molten resin, leakage of the gas present in the cavity 11 does not occur. Furthermore, a flow path cross-sectional area of the gas pathway of the die parting portion is extremely small. The gas pathway of the die parting portion acts a passage resistance with respect to air or the like.

In the molding of the resin molded product 1 by use of the injection molding die 10, as the filling of the inside of the cavity 11 with the molten resin progresses, the region close to the die parting portion of the cavity 11 which is covered with the molten resin increases, in accordance with this, a gas pathway that can function as a exhaust passage of the gas present in the cavity 11 in the die parting portion decreases, and therefore a pressure of the gas present in the cavity 11 increases.

However, in the molding of the resin molded product 1 by use of the injection molding die 10, since the gas present in the cavity 11 can also be discharged from the ejector pin holes 39, an increase in pressure of the gas present in the cavity 11 in accordance with progress of filling of the inside of the cavity with the molten resin can be reduced as compared with a case where an ejector pin hole 39 is absent.

In the molding of the resin molded product 1 by use of the injection molding die 10, after completion of filling of the cavity 11 with the molten resin, when reduction in volume of the resin molded product 1 occurs due to lowering of the temperature thereof after molding, air enters from the die parting portion to a portion between the main-body back side molding surface 31 of the core die 30 and the molded-product-main-body back surface 1c, and the sink portion gap 13 is formed by the entering of the air.

However, in a practical manner, as described above, entering of air from the ejector pin hole 39 or the like to the back surface side of the resin molded product 1 preferentially progresses.

A profile of the gas pathways which open at the cavity side 11 in the extending direction of the die parting portion is not always even. However, the gas pathways which open at the cavity side 11 are in a state of being scattered on the entire die parting portion in the extending direction until the injection molding die 10 is demolded.

The sink portion gap 13 due to inflow of air through the gas pathways of the die parting portion can be formed between the outer-periphery of the main-body back side molding surface 31 of the core die 30 and the outer-periphery of the molded-product-main-body back surface 1c so as to be provided on the entire outer-periphery thereof.

In the molding of the resin molded product 1, the injection molding die 10 forms the sink portion gap 13 due to entering of air from the ejector pin hole 39 and thereby can form the sink portion gap 13 over the entire portion between the main-body back side molding surface 31 of the core die 30 and the molded-product-main-body back surface 1c. Accordingly, in the molding of the resin molded product 1 by use of the injection molding die 10, it is possible to stably realize the prevention of sink from being generated at the portions of the design surface 1b of the molded product which correspond to the molded-product-main-body back surface 1c.

As described above, entering of air from the gas pathways of the die parting portion to the portions between the main-body back side molding surface 31 of the core die 30 and the molded-product-main-body back surface 1c hardly occurs. Consequently, it is difficult to stably form the sink portion gap 13 extending from the die parting portion so as to reach the projected-portion molding recesses 38 located at the portions which are separated from the die parting portion.

As shown in FIG. 2, as long as the entirety of all of the projected-portion molding recesses 38 of the core die 30 are configured to be located inside the projected-portion-molding-setting region 100A with respect to the ejector pin holes 39 (ventilation pass), regardless of the presence, absence, or the like of the entering of air into a portion between the main-body back side molding surface 31 of the core die 30 and the molded-product-main-body back surface 1c through the gas pathways of the die parting portion, sink can be freely generated on the molded-product projected portion 1d to be molded in each of projected-portion molding recess 38 after molding. Therefore, according to the injection molding die 10, it is possible to stably realize the prevention of sink from being generated at the portions of the design surface 1b of the molded product which correspond to the molded-product projected portions 1d.

### Second Embodiment

Next, an injection molding die 210 according to a second embodiment of the invention will be described.

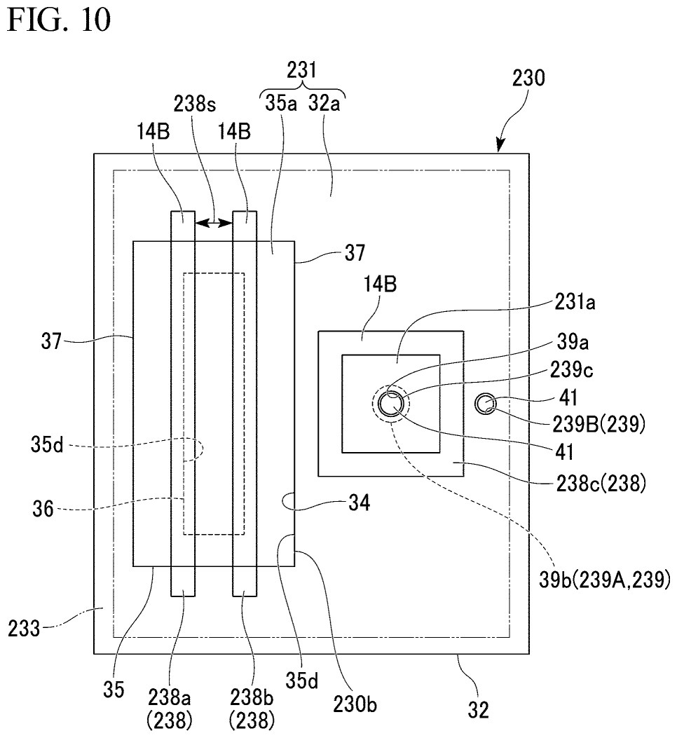

FIG. 9 is a cross-sectional front view showing the injection molding die 210 according to the aforementioned embodiment, and FIG. 10 is a view showing a core die 230 of the injection molding die 210 of FIG. 9 and is a plan view showing a configuration when viewed from a main-body back side molding surface 231 of the core die 230.

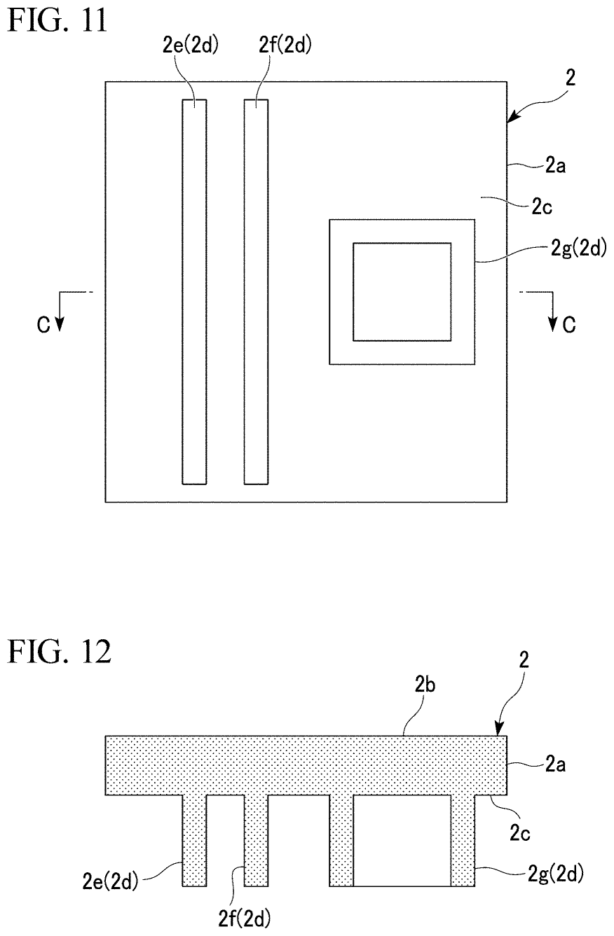

Additionally, FIG. 11 is a view showing a resin molded product 2 (hereinbelow, also simply referred to as a molded product) obtained by molding using the injection molding die 210 of FIG. 9 and is a view showing a configuration when viewed from a back surface side 2c of the molded product 2, and FIG. 12 is a cross-sectional front view (a view taken along the line C-C shown in FIG. 11) showing the molded product 2 of FIG. 11.

Note that, in FIGS. 9 and 10, common reference numerals are used for the elements of the injection molding die 210 which are identical to those of the injection molding die 10 according to the first embodiment, and the explanations thereof are omitted or simplified here.

As shown in FIG. 9, the injection molding die 210 includes: a cavity die 220; and the core die 230 that exists to be openable and closable with respect to the cavity die 220 and forms a cavity 14 between the cavity die 220 and the core die when the core die is closed and coupled to the cavity die 220.

The injection molding die 210 shown in FIG. 9 is used in a molding method of obtaining a plate-shaped molded-product main body 2a and the resin molded product 2 including projected portions 2d protruding from the back surface 2c that are on the opposite side of a design surface 2b on one surface of the molded-product main body 2a.

A molding recess 221 is formed on the cavity die 220 to mold the molded-product main body 2a of the resin molded product 2.

A molding surface 231 (a back side molding surface, also referred to as a main-body back side molding surface in the description) is formed on the core die 230 to mold the back surface side 2c that is on the opposite side of the design surface 2b of the molded product 1.

The design surface 2b of the resin molded product 2 is formed by an inside bottom surface 222 of the molding recess 221 of the cavity die 220. Hereinbelow, the inside bottom surface 222 of the molding recess 221 of the cavity die 220 is also referred to as a design-surface molding surface.

FIG. 9 shows a mold clamping state in which the core die 230 is closed and coupled to the cavity die 220. Moreover, FIG. 9 shows a state where the resin molded product 2 exists in the cavity 14 serving as a space for resin molding which is ensured between the cavity die 220 and the core die 230 which are closed and coupled to each other. The resin molded product 2 is formed by solidification of the molten resin that is injected and filled to the inside of the cavity 14 from a gate of the injection molding die 210 which is not shown in the drawings.

As a resin used to form the resin molded product 2, a resin can be adopted which is applicable to the resin used to form the resin molded product 1 explained in the first embodiment.

The injection molding die 210 includes a temperature regulation mechanism 12 that maintains the temperature of the design-surface molding surface 222 of the cavity die 220 during resin molding to be substantially the same as the temperature of the portion that is located at the core die 230 of the inner surface of the cavity die 220.

As the temperature regulation mechanism 12, a mechanism having the configuration that is the same as that of the temperature regulation mechanism 12 explained in the first embodiment may be adopted.

The temperature regulation mechanism 12 of the injection molding die 210 shown in FIG. 9 includes the cavity die heating mechanism 121 provided with the heating pipe 121a attached to the cavity die 220 and the core die heating mechanism 122 provided with the heating pipe 122a attached to the core die 230.

Note that, the temperature regulation mechanism 12 is only necessary to have a mechanism that is able to stabilize the temperature of an inner surface of the cavity 14 on both the cavity side and the core side to be the same as each other, and the specific configuration of the mechanism can be appropriately modified.

A parting surface 233 at the periphery of the main-body back side molding surface 231 of the core die 230 is closed and coupled to a parting surface 223 at the periphery of an opening portion of the molding recess 221 of the cavity die 220, an opening portion of the molding recess 221 is closed by the core die 230, and therefore the cavity 14 of the injection molding die 210 shown in FIG. 9 is ensured.

The core die 230 is closed and coupled to the cavity die 220 such that the parting surface 233 overlaps the parting surface 223 of the cavity die 220.

The parting surface 223 of the cavity die 220 is formed to surround the opening portion of the molding recess 221.

As shown in FIG. 9, the main-body back side molding surface 231 of the core die 230 is a surface of the core die 230 that is closed and coupled to the cavity die 220 which face the cavity 14 and is a surface facing the molding recess 221. The parting surface 233 of the core die 230 is formed to surround the main-body back side molding surface 231 so as to correspond to the parting surface 223 of the cavity die 220.

Note that, the main-body back side molding surface 231 of the core die 230 shown in FIGS. 9 and 10 is a flat surface continuous to the parting surface 233 of the core die 230.

However, a part or entire of the main-body back side molding surface 231 of the core die 230 may have a shape that protrudes toward the molding recess 221 of the cavity die 220 so as to enter the inside of the molding recess 221 of the cavity die 220 when mold-clamping.

The gas pathways which are provided with microscopic uneven portions formed between the parting surface 233 of the core die 230 and the parting surface 223 of the cavity die 220 and which are the same as those of the die parting portion of the injection molding die according to the first embodiment are ensured at a matching portion (die parting portion) at which the parting surface 233 of the core die 230 is closed and coupled to the parting surface 223 of the cavity die 220.

The gas pathways of the die parting portion of the injection molding die 210 function as an exhaust passage that discharges the gas present in the cavity 14 to the outside of the die when injecting and filling of the molten resin to the cavity 14 from a gate which is not shown in the drawings.

The core die 230 of the injection molding die 210 shown in FIGS. 9 and 10 includes a metal core-die main body 32 and a bushing 35 that is accommodated and fixed in a bushing storage recess 34 formed in the core-die main body 32.

The main-body back side molding surface 231 of the core die 230 is formed of a back side molding main surface 32a formed on the core-die main body 32 and a top surface 35a (hereinbelow, also referred to as a bushing top surface) formed on the bushing 35 and is continuous to the back side molding main surface 32a.

The cavity die 220 and the core die 230 are each formed of a metal member.

As shown in FIGS. 9 and 10, projected-portion molding recesses 238 that molds the projected portions 2d of the resin molded product 2 are formed on the core die 230 so as to be depressed from the main-body back side molding surface 231.

As shown in FIG. 9, the cavity 14 is configured to include: a main-body molding region 14A that is located at the inside surrounded by an inner surface of the molding recess 21 of the cavity die 220 the main-body back side molding surface 231 of the core die 230 in a mold clamping state in which the core die 230 is closed and coupled to the cavity die 220; and the projected-portion molding recesses 238 formed in the core die 230. The inner surface of the cavity 14 includes inner surfaces of the projected-portion molding recesses 238.

The injection molding die 210 cools and solidifies molten resin that is injected to the cavity 14 from a gate which is not shown in the drawings in a mold clamping state and molds the resin molded product 2 having an outer shape following the inner surface of the cavity 14.

The molded-product main body 2a of the resin molded product 2 is molded by the main-body molding region 14A of the cavity 14.

The projected portions 2d of the resin molded product 2 are molded by the projected-portion molding recesses 238 formed on the core die 230.

The projected-portion molding recesses 238 formed on the core die 230 function as projected-portion molding regions that mold the molded-product projected portions 2d.

The projected portions 2d of the resin molded product 2 shown in FIGS. 11 and 12 are a pair of ribs 2e and 2f formed on the back surface 2c (hereinbelow, also referred to as a molded-product-main-body back surface) of the molded-product main body 2a so as to extend straight in parallel to each other, and tubular projected portion 2g.

Regarding the molded-product main body 2a of the resin molded product 2 shown in FIGS. 11 and 12, hereinbelow, an extending direction of each of the ribs 2e and 2f is referred to as an extending direction of the main body, a direction perpendicular to the extending direction of the main body on a molded-product-main-body back surface 2c is referred to as a width direction of the main body.

The extending direction of the main body is the vertical direction of FIG. 11 and the paperface depth direction of FIG. 12.

The width direction of the main body is the horizontal direction of FIG. 11 and the horizontal direction of FIG. 12.

The paired ribs 2e and 2f of the resin molded product 2 are formed separately from each other in the width direction of the main body of the molded-product main body 2a.

The tubular projected portion 2g is formed at a position away from the paired ribs 2e and 2f in the width direction of the main body.

The projected-portion molding recesses 238 of the core die 230 shown in FIGS. 9 and 10 are formed on the core die 230 at a plurality of points corresponding to positions of projected portions 2d of the resin molded product 2.

Rib molding recesses 238a and 238b serving as the projected-portion molding recesses 238 that mold the ribs 2e and 2f of the resin molded product 2 and a tubular-projected-portion molding recess 238c serving as the projected-portion molding recess 238 that molds the tubular projected portion 2g are formed on the core die 230.

The rib molding recesses 238a and 238b are formed on the bushing 35 in a groove shape that is depressed from the bushing top surface 35a.

As shown in FIGS. 9 and 10, the tubular-projected-portion molding recess 238c of the core die 230 is a groove (go-around groove) that is formed and extended in an endless go-around shape on the core-die main body 32 and is depressed from the back side molding main surface 32a.

The tubular projected portion 2g of the resin molded product 2 shown in FIGS. 11 and 12 is formed in a square tubular shape.

The tubular-projected-portion molding recess 238c shown in FIGS. 9 and 10 is a go-around groove that ensures a groove width corresponding to a thickness of the tubular projected portion 2g and is formed and extended in a rectangular shape on a core-die main body 22.

In other cases, the tubular-projected-portion molding recess 238c that is the go-around groove is not limited to a rectangular shape but may be formed and extended in a circular shape or a polygonal shape other than quadrangular shape.

Hereinbelow, in explanation regarding the core die 230, a direction (horizontal direction of FIG. 9 and the horizontal direction of FIG. 10) corresponding to the width direction of the main body of the molded-product main body 2a of the resin molded product 2 inside the cavity 14 of the injection molding die 210 in a mold clamping state shown in FIG. 9 is represented as a width direction, and a direction (paperface depth direction of FIG. 9 and the vertical direction of FIG. 10) corresponding to the extending direction of the main body of the molded-product main body 2a is represented as an extending direction.

The rib molding recesses 238a and 238b of the core die 230 shown in FIGS. 9 and 10 are each formed in a groove shape extending in the extending direction of the core die 230. The bushing top surface 35a of the core die 230 is formed in a rectangular shape in a longitudinal direction that is the extending direction of the core die 230.

The bushing top surface 35a and the rib molding recesses 238a and 238b are located at positions away from the tubular-projected-portion molding recess 238c in the width direction of the core die 230.

As shown in FIG. 9, a gas storage space 36 that is used to temporarily store gas present in the cavity 14 when injecting and filling of the molten resin to the inside of the cavity 14 of the injection molding die 210 in a mold clamping state, and a ventilation pass 37 that cause the gas storage space 36 to be communicated with (connected to) the cavity 14 such that ventilation is possible are ensured in the core die 230.

In addition, as shown in FIGS. 9 and 10, an ejector pin hole 239 opening at the back side molding main surface 32a of the core-die main body 32 is formed in the core die 230.

As shown in FIG. 9, the bushing storage recess 34 is formed on the core-die main body 32 so as to be depressed from the back side molding main surface 32a.

The bushing top surface 35a is an end face on the opposite side of a back surface 35b (hereinbelow, also referred to as a bushing back surface) of the bushing 35 which faces an inside bottom surface 34a of the bushing storage recess 34.

The bushing 35 shown in FIGS. 9, 10, or the like uses an impervious member such as a metal member.

The bushing 35 is fitted into the inside of the bushing storage recess 34 such that a side peripheral surface 35c thereof comes into contact with an inner peripheral face of the bushing storage recess 34 and the back surface 35b comes into contact with the inside bottom surface 34a of the bushing storage recess 34.

The bushing top surface 35a is formed such that the entirety thereof is continuous to the back side molding main surface 32a in a state where the bushing 35 is fitted and fixed to the inside of the bushing storage recess 34 so as to cause the back surface 35b thereof to come into contact with the inside bottom surface 34a of the bushing storage recess 34.

A recess 35d (bushing back side recess) depressed from the back surface 35b of the bushing 35 is formed on the bushing 35 of the core die 230 shown in FIGS. 9 and 10.

In the core die 230 shown in FIGS. 9 and 10, the gas storage space 36 is ensured by the recess 35d of the bushing 35. The bushing back side recess 35d shown in FIGS. 9 and 10 as examples is formed in a groove shape that extends straight along the bushing back surface 35b with a constant section size. Both ends of the groove-shaped bushing back side recess 35 shown in FIG. 10 in the extending direction thereof do not reach the side peripheral surface 35c of the bushing 35.

The bushing back side recess 35d is a recess formed on the bushing 35 so as not to open the side peripheral surface 35c of the bushing 35. Except for the opening portion that opens at the bushing back surface 35b of the bushing back side recess 35d, the bushing back side recess 35d does not have an opening portion that opens the periphery of the bushing 35.

Moreover, the bushing back side recess 35d does not also have the rib molding recesses 238a and 238b of the core-die main body 32.

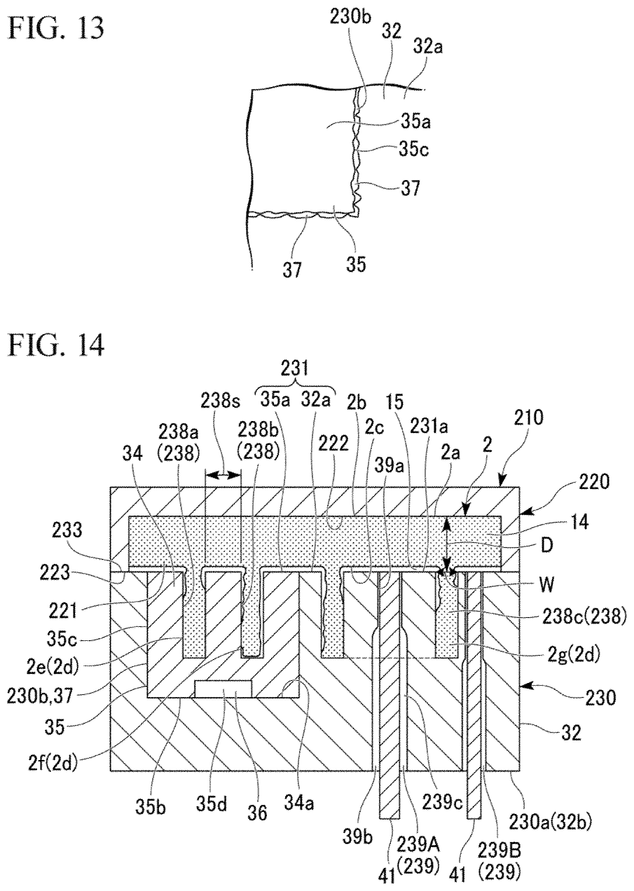

FIG. 13 is an enlarged view (an enlarged plan view) showing a configuration when viewed from the main-body back side molding surface side 231 of the core die 230 which is located close to a boundary between the inner surface of the bushing storage recess 34 and the bushing 35.

As shown in FIG. 13, by microscopic uneven portions formed due to surface roughnesses of the back surface 35b of the bushing 35 and the side peripheral surface 35c and microscopic uneven portions formed due to surface roughness of the inner surface of the bushing storage recess 34, a microscopic ventilation pass 37 that causes the cavity 14 to be communicated with the gas storage space 36 such that ventilation is possible is ensured between the inner surface of the bushing storage recess 34 and the bushing 35. One end of the ventilation pass 37 opens at the main-body back side molding surface 231 of the core die 230, and the other end of the ventilation pass 37 opens at the gas storage space 36.

Hereinbelow, the ventilation pass 37 that causes the cavity 14 to be communicated with the gas storage space 36 such that ventilation is possible is also referred to as a storage-space connection ventilation pass.

When the molten resin is injected and filled to the inside of the cavity 14 of the injection molding die 210 in a mold clamping state, it is possible to cause the gas present in the cavity 14 to flow to the gas storage space 36 through the storage-space connection ventilation pass 37 in accordance with progress of filling of the cavity with the molten resin.

The storage-space connection ventilation pass 37 extends between the inner surface of the bushing storage recess 34 and the bushing 35 such that the maximum size thereof in a direction vertical to the inner surface of the bushing storage recess 34 is approximately 0.01 mm (0.005 to 0.015 mm) and is a hole-shaped space that causes the cavity 14 to be communicated with the bushing back side recess 35d. Since the storage-space connection ventilation pass 37 is extremely narrow space that is ensured between the inner surface of the bushing storage recess 34 and the bushing 35, molten resin that is injected and supplied to the cavity 14 does not enter the space; or even where entering of molten resin thereto occurs, the molten resin is extremely slight.

The storage-space connection ventilation pass 37 allows gas flow between the gas storage space 36 and the cavity 14 and limits molten resin from leaking out from the cavity 14 to the gas storage space 36.

As shown in FIG. 9, the ejector pin hole 239 is formed on the core-die main body 32 so as to penetrate from the back side molding main surface 32a to a bottom surface 32b (hereinbelow, also referred to as a core-die-main-body bottom surface) of the core-die main body 32 on the opposite side of the back side molding main surface 32a.

Hereinbelow, an opening portion of the ejector pin hole 239 which opens at the main-body back side molding surface 231 of the core die 230 (more particularly, the back side molding main surface 32a of the core-die main body 32) is also referred to as a molding-surface side opening portion. Additionally, hereinbelow, an inside region 231a that is surrounded by the opening portion of the tubular-projected-portion molding recess 238c of the back side molding main surface 32a of the core-die main body 32 shown in FIGS. 9 and 10 is also referred to as a circumference-recess-inside region.

The ejector pin hole 239 (circumference-recess-inside pin hole, represented by reference numeral 239A in FIGS. 9 and 10) having a molding-surface side opening portion which is located at the circumference-recess-inside region 231a of the main-body back side molding surface 231 of the core die 230 is formed on the core die 230 shown in FIGS. 9 and 10.

Furthermore, the ejector pin hole 239 (circumference-recess-outside pin hole, represented by reference numeral 239B in FIGS. 9 and 10) having a molding-surface side opening portion which is located outside the circumference-recess-inside region 231a of the main-body back side molding surface 231 of the core die 230 is also formed on the core die 230 shown in FIGS. 9 and 10.

Note that, the number of circumference-recess-inside pin holes 239A and the circumference-recess-outside pin holes 239B which are formed on the core die 230 is not limited to the drawings shown as an example can be appropriately modified.

The ejector pin 41 is inserted into the ejector pin hole 239. The injection molding die 210 includes the ejector pins 41.

As a configuration of the ejector pin hole 239, a configuration may be adopted which applicable to the ejector pin hole 39 that is formed to penetrate through the core die 30 of the injection molding die 10 (refer to FIG. 1) according to the first embodiment.

As shown in FIG. 9, the ejector pin hole 239 includes: the pin guide hole 39a that is formed so as to extend from the back side molding main surface 32a of the core-die main body 32 toward the core-die main body bottom surface 32b; and a large-diameter hole 39b that is formed to have a diameter larger than that of the pin guide hole 39a and extends from the pin guide hole 39a to the bottom surface side 30a of the core die. The a large-diameter hole 39b open at the core-die main body bottom surface 32b.

Due to driving of a pin movement device which is not shown in the drawings, the ejector pins 41 can switch between a standby position (position shown in FIG. 9) at which the end portions accommodated in the pin guide holes 39a do not protrude from the pin guide holes 39a toward the cavity die 220 and a protruding position at which the end portions protrude from the pin guide holes 39a toward the cavity die 220.

As the ejector pins 41, a pin is adopted in which an outer diameter of the entirety of the end portion accommodated in the pin guide hole 39a is smaller than an internal diameter of the pin guide hole 39a by approximately 0.02 mm (0.01 to 0.03 mm).

A gap 239c that is ensured between an inner surface of the ejector pin hole 239 and the ejector pin 41 located inside the ejector pin hole 239 functions as a ventilation pass that connects the cavity 14 of the injection molding die 210 in a mold clamping state and an external space of the core die 230 such that ventilation of gas flow is possible.

Hereinbelow, the gap 239c between the inner surface of the ejector pin hole 239 and the ejector pin 41 inside the ejector pin hole 239 is also referred to as a pin-hole ventilation pass.

The ejector pin holes 239 have function of ensuring the pin-hole ventilation pass 239c in the core die 230.

Note that, the outer-periphery of a molding-surface side opening portion that opens at the main-body back side molding surface 231 of the pin-hole ventilation pass 239c is substantially the same as the outer-periphery of a molding-surface side opening portion that opens at the main-body back side molding surface 231 of the ejector pin hole 239.

In the description, not only the pin-hole ventilation passes 239c but also the ejector pin holes 239 are referred to as a ventilation pass that connects the cavity 14 of the injection molding die 210 in a mold clamping state and the external space of the core die 230 such that ventilation is possible.

Since the portion of the pin-hole ventilation passes 239c which is between the inner surface of the pin guide hole 39a of the ejector pin hole 239 and the end portion of the ejector pin 41 at the standby position is an extremely narrow space, molten resin that is injected and supplied to the cavity 14 does not enter the space. Alternatively, even where entering of molten resin occurs, an amount of the molten resin is extremely slight. The pin-hole ventilation passes 239c each have a configuration in which entering of molten resin from the cavity 14 substantially does not occur.

The molding of the resin molded product 2 by use of the injection molding die 210 is achieved by injecting and filling of the molten resin to the inside of the cavity 14 of the injection molding die 210 in a mold clamping state and by cooling and solidifying the molten resin inside the cavity 14. When the injection molding die 210 is in a mold clamping state, the ejector pins 41 are disposed at the standby position.

The resin molded product 2 molded by cooling and solidifying the molten resin inside the cavity 14 is demolded from the cavity die 220 by mold-opening of the injection molding die 210. Next, the resin molded product 2 is pressed by the ejector pins 41 that moves from the standby position to the protruding position with respect to the core die 230 by driving the pin movement device and is thereby removed (demolded) from the core die 230.

The storage-space connection ventilation pass 37 and the ejector pin holes 239 (specifically, the pin-hole ventilation passes 239c) of the core die 230 function as an exhaust passage that discharges the gas present in the cavity 14 (air, discharged gas from molten resin, or the like) from the cavity 14 when injecting and filling of the molten resin to the inside of the cavity 14 of the injection molding die 210 in a mold clamping state.

When the molten resin is injected and filled to the inside of the cavity 14, the storage-space connection ventilation pass 37 guides the gas present in the cavity 14 to the gas storage space 36 of the core die 230. The ejector pin holes 239 (in detail, the pin-hole ventilation passes 239c) discharges the gas present in the cavity 14 to the outside of the injection molding die 210 (outer surface side of the core die 230).

Note that, “outer surface of the core die 230” means an external surface that is exposed without being covered with the cavity die 220 of the core die 230 in the injection molding die 210 which is in a mold clamping state.

The ends of the ejector pin holes 239 of the core die 230 in the extending direction shown in FIGS. 1 and 2 and the other ends thereof in the extending direction open at the main-body back side molding surface 231 and the core-die bottom surface 230a, respectively. The core-die bottom surface 30a is part of the outer surface of the core die 230.

Hereinbelow, an opening portion of the ejector pin hole 239 which opens at an outer surface of the core die is also referred to as a core-die-outer-surface opening portion.

Since a portion between an inner surface of the pin guide hole 39a of the ejector pin hole 239 of the pin-hole ventilation pass 239c and the end portion of the ejector pin 41 at the standby position is an extremely narrow space, passage resistance occurs when gas flows therethrough. Moreover, when the molding-surface side opening portion of the pin-hole ventilation pass 239c is occluded by molten resin that is injected to the inside of the cavity 14, discharge of the gas present in the cavity 14 from the pin-hole ventilation pass 239c is stopped.

As shown in FIG. 13, opening portions (hereinbelow, also referred to as a molding-surface side opening portion) that open at the main-body back side molding surface 231 of the storage-space connection ventilation pass 37 between the core-die main body 32 and the bushing 35 exist at a plurality of positions in the extending direction of a matching portion 230b (hereinbelow, also referred to as a bushing fitting matching portion) of an inner peripheral face of the bushing storage recess 34 of the core-die main body 32 and a side peripheral surface of the bushing 35. As shown in FIG. 10, the bushing fitting matching portion 230b extends in substantially the entire length in the extending direction of the core die 230 of the main-body back side molding surface 231 of the core die 230. The molding-surface side opening portions of the storage-space connection ventilation passes 37 exist throughout at a plurality of positions in the extending direction along the main-body back side molding surface 231 of the bushing fitting matching portion 230b.

In the core die 230 shown in FIGS. 9 and 10, the molding-surface side opening portions of the storage-space connection ventilation passes 37 widely exist on one-side region of the main-body back side molding surface 231 of the core die 230 in a width direction.

The number of ejector pin holes 239 of the core die 230 shown in FIGS. 9 and 10 is only two. The circumference-recess-inside pin hole 239A (ejector pin hole 239) and the circumference-recess-outside pin hole 239B (ejector pin hole 239) are formed in the core die 230 shown in FIGS. 9 and 10 one by one.

However, the number of ejector pin holes 239 of the core die 230 may be three or more.

Not only the ejector pin hole 239 (circumference-recess-inside pin hole 239A) that opens at the circumference-recess-inside region 231a of the main-body back side molding surface 231 but also a plurality of the ejector pin holes 239 (circumference-recess-outside pin holes 239B) that open at a region outside the tubular-projected-portion molding recess 238c of the main-body back side molding surface 231 may be formed in the core die 230.

Furthermore, a configuration may also be adopted in which a plurality of the ejector pin holes 239 (circumference-recess-inside pin hole 239A) that open at the circumference-recess-inside region 231a of the main-body back side molding surface 231 are formed in the core die 230.

Note that, the ejector pins 41 are inserted into all of the ejector pin holes 239 formed on the core die 230 which are similar to the ejector pin holes 239 shown in FIGS. 9 and 10 as examples.

Each configuration of the ejector pin hole 239 and the ejector pin 41 and operation of the ejector pin 41 are the same as those of the ejector pin hole 239 and the ejector pin 41 shown in FIGS. 9 and 10 as examples. The pin-hole ventilation pass 239c similar to the ejector pin hole 239 shown in FIGS. 9 and 10 as examples is ensured in each ejector pin hole 239.

When molding operation is carried out by use of the injection molding die 210 shown in FIGS. 9 and 10, the molten resin is injected and filled to the inside of the cavity 14 from a resin gate which is not shown in the drawings. At this time, air that initially exists inside the cavity 14 or gas generated from the molten resin is compressed in accordance with filling of the cavity with the molten resin. The compressed gas is gradually discharged from the ejector pin holes 239 or the matching portion of the parting surfaces 223 and 233. However, the faster the injection speed of molten resin and the stronger the degree of contact (mold clamping force) between the parting surfaces 223 and 233 of the dies, the higher the internal pressure of the gas present in the cavity 14. Moreover, the pressure inside the gas storage space 36 increases until the molding-surface side opening portions of the storage-space connection ventilation passes 37 of all of the bushing fitting matching portion 230b is occluded by the molten resin inside the cavity 14.

Consequently, in the step of injecting and filling of the molten resin to the inside of the cavity 14, gas having a pressure higher than an atmospheric pressure is stored in the gas storage space 36 of the core die 230.

As a configuration of the injection molding die 210, a configuration may preferably be adopted in which a flow pathway of the molten resin inside the cavity 14 is designed such that a state is obtained where, after the molding-surface side opening portions of all of the ejector pin holes 239 that open at the main-body back side molding surface 231 is occluded by the molten resin inside the cavity 14, the entirety of the bushing fitting matching portion 230b near the cavity 14 is covered with the molten resin in accordance with further progress of filling of the inside of the cavity 14 with the molten resin.

The gas storage space 36 is configured such that ventilation between the gas storage space and the storage-space connection ventilation pass 37 is only possible. Airtightness is ensured on an inner surface other than the portions at which the storage-space connection ventilation passes 37 of the gas storage space 36 open.

Accordingly, as filling of the cavity 14 with the molten resin progresses, the gas present in the cavity 14 flows to the gas storage space 36 so as to be extruded from the cavity 14, and a gas pressure inside the gas storage space 36 increases.

The pin-hole ventilation pass 239c and the storage-space connection ventilation pass 37 each function as an exhaust passage that discharges the gas present in the cavity 14 to the outside of the cavity 14 in accordance with progress of injecting and filling of the molten resin to the inside of the cavity 14.

The pin-hole ventilation pass 239c and the storage-space connection ventilation pass 37 each have a function of minimizing an increase in pressure of the gas present in the cavity 14 due to progress of injecting and filling of the molten resin to the inside of the cavity 14 and of preventing the molded resin from being burned by gas due to an increase in pressure of the gas present in the cavity 14.

The pin-hole ventilation pass 239c functions as a gas entering path that causes air to enter between the molded-product-main-body back surface 2c and the main-body back side molding surface 231 of the core die 230 from the outside of the injection molding die 210 (outer surface side of the core die 230) when reduction in volume of the resin molded product 2 inside the cavity 14 of the injection molding die 210 in a mold clamping state occurs due to lowering of the temperature thereof after molding.

The storage-space connection ventilation pass 37 functions as a gas entering path that guides the gas stored in the gas storage space 36 of the core die 230 into between the molded-product-main-body back surface 2c and the main-body back side molding surface 231 of the core die 230 when reduction in volume of the resin molded product 2 inside the cavity 14 of the injection molding die 210 in a mold clamping state occurs due to lowering of the temperature thereof after molding. When reduction in volume of the resin molded product 2 inside the cavity 14 of the injection molding die 210 in a mold clamping state occurs due to lowering of the temperature thereof after molding, the gas stored in the gas storage space 36 in the step of injecting and filling of the molten resin to the cavity 14 is discharged through the storage-space connection ventilation pass 37 to between the molded-product-main-body back surface 2c and the main-body back side molding surface 231 of the core die 230.

A configuration such as a gas entering path or the like which causes gas to be able to enter a portion between the design surface 2b of the resin molded product 2 and the design-surface molding surface 222 of the cavity die 220 is not present in the cavity die 220.

In contrast, since entering of gas is possible on the molded-product-main-body back surface side 2c of the resin molded product 2 between the molded-product-main-body back surface 2c and the main-body back side molding surface 231 of the core die 230 through the storage-space connection ventilation pass 37 between the inner surface of the bushing storage recess 34 and the bushing 35 and through the ejector pin holes 239, sink is easily generated as compared with the design surface side 2b of the resin molded product 2.

The temperature of the design-surface molding surface 222 of the cavity die 220 is maintained by the temperature regulation mechanism 12 by heating so as to be higher than the temperature of the main-body back side molding surface 231 of the core die 230. For this reason, solidification of the resin material during molding (resin used to form the resin molded product 2) on the molded-product-main-body back surface side 2c progresses while maintaining the design-surface molding surface 222 to be in close contact with the cavity die 220. At this time, since entering of gas is possible between the molded-product-main-body back surface 2c and the main-body back side molding surface 231 of the core die 230 through the storage-space connection ventilation pass 37 and the ejector pin holes 239, the portions close to the back surface 2c of the molded-product main body 2a is not restrained by the core die 230 but can cause sink to be freely generated thereat.

As a result, in the molding of the resin molded product 2 by use of the injection molding die 210, as shown in FIG. 14, the sink that is generated by reduction in volume of the resin molded product 2 in accordance with lowering of the temperature of the resin molded product 2 molded inside the cavity 14 can be concentrated to the molded-product-main-body back surface side 2c. As shown in FIG. 14, a gap 15 (hereinbelow, also referred to as a sink portion gap) is formed by sink on the molded-product-main-body back surface 2c between the molded-product-main-body back surface 2c of the resin molded product 2 and the main-body back side molding surface 231 of the core die 230.

The concentration of the sink to the molded-product-main-body back surface side 2c, which is generated by reduction in volume of the resin molded product 2 in accordance with lowering of the temperature of the resin molded product 2, effectively contributes to prevention of sink from being generated on the design surface 2a of the resin molded product 2.

When the filling of the inside of the cavity 14 of the injection molding die 210 with the molten resin is completed, the gas inside the gas storage space 36 has a gas pressure which is higher than an atmospheric pressure and is applied onto the molded-product-main-body back surface 2c of the resin molded product 2 that is molded inside the cavity 14 of the injection molding die 210 in a mold clamping state.

Consequently, as shown in FIG. 14, when reduction in volume of the resin molded product 2 inside the cavity 14 of the injection molding die 210 in a mold clamping state occurs due to lowering of the temperature thereof, it is possible to separate the molded-product-main-body back surface 2c of the resin molded product 2 from the main-body back side molding surface 231 of the core die 230 by the pressure of the gas inside the gas storage space 36.

The configuration of applying the gas stored in the gas storage space 36 onto the molded-product-main-body back surface 2c of the resin molded product 2 is advantageous to form the sink portion gap 15 between the molded-product-main-body back surface 2c of the resin molded product 2 and the main-body back side molding surface 231 of the core die 230 as wide as possible.

The gas storage space 36 is formed such that a volume of the gas storage space 36 is smaller than the volume of the cavity 14.

In consideration of a volume of the cavity 14 or the like, the gas storage space 36 shown in FIGS. 9 and 10 ensures a volume that can limit an increase in pressure of the gas present in the cavity 14 in the step of injecting and filling of the molten resin to the cavity 14 to be in a degree in which burning of the molded resin by gas does not occur.

However, when a volume of the gas storage space 36 increases, the pressure of the gas stored in the gas storage space 36 which presses the molded-product-main-body back surface 2c of the resin molded product 2 decreases. Therefore, the volume of the gas storage space 36 is necessary not to be overlarge in a range of reliably forming the sink portion gap 15. Moreover, in the case where an amount of gas discharged from the gas storage space 36 to the cavity 14 is excessively large when reduction in volume of the resin molded product 2 inside the cavity 14 occurs due to lowering of the temperature thereof, gas enters the inside of the molded product 2 and causes a defect thereof; in order to prevent this, the volume of the gas storage space 36 is not overlarge.

By machining the inner surface of the back side recess 35d of the bushing 35 which is a different body from the core-die main body 32, a volume of the back side recess 35d can be adjusted.

For example, a volume of the gas storage space 36 in the core die 230 can be suitably adjusted by machining the inner surface of the side recess 35d using a try-and-error method.

Regarding the injection molding die 210, the cavity die 220, and the core die 230 which are in a mold clamping state, hereinbelow, a direction of a pressing force pressing the core die 230 against the cavity die 220 when mold-clamping the injection molding die 210 (mold clamping direction), that is, the vertical direction of the FIG. 9 is also referred to as a height direction.

When the injection molding die 210 is in a mold clamping state, the design-surface molding surface 222 and the main-body back side molding surface 231 are located separately from each other via with the cavity 14 in the height direction of the injection molding die 210 (die height direction).

The molding-surface side opening portions of the storage-space connection ventilation passes 37 of a bushing fitting matching portion 231b are present on the entire side periphery of the bushing 35.

In FIGS. 9 and 10, each of the portions on the main-body back side molding surface 231 is located on the main-body back side molding surface 231 in one or both of a range of 100 mm from the molding-surface side opening portion the storage-space connection ventilation pass 37 between the inner surface of the bushing storage recess 34 and the bushing 35 and a range of 100 mm from the molding-surface side opening portion of the ejector pin hole 239.

Hereinbelow, the range of 100 mm from the molding-surface side opening portion the storage-space connection ventilation pass 37, and the range of 100 mm from the molding-surface side opening portion of the ejector pin hole 239 are also referred to as a projected-portion-molding-setting region. All of the opening portions that open at the main-body back side molding surface 231 of the rib molding recesses 238a and 238b of the core die 230 are located in the projected-portion-molding-setting regions with respect to the molding-surface side opening portions of the storage-space connection ventilation passes 37 of the main-body back side molding surface 231.

Particularly, FIGS. 9 and 10 show an example case where the entirety of the main-body back side molding surface 231 is a flat surface extending in the horizontal direction perpendicular to the height direction of the core die 230 (hereinbelow, also referred to as a core die horizontal direction).

However, a configuration may also be adopted in which the main-body back side molding surface 231 of the core die 230 has a portion (may be a curved portion) that is inclined with respect to the core die horizontal direction.

The rib molding recesses 238a and 238b of the core die 230 in the entire length thereof are located in one or a plurality of projected-portion-molding-setting regions with respect to the molding-surface side opening portions of the storage-space connection ventilation passes 37.

A portion which is not located in the projected-portion-molding-setting region with respect to the molding-surface side opening portion of the storage-space connection ventilation pass 37 is not present in the rib molding recesses 238a and 238b.

Opening portions that open at the main-body back side molding surface 231 of the tubular-projected-portion molding recess 238c of the core die 230 are located in the projected-portion-molding-setting regions with respect to the molding-surface side opening portions of the ejector pin holes 239 (circumference-recess-inside pin hole 239A) located at the circumference-recess-inside region 231a.

The tubular-projected-portion molding recess 238c of the core die 230 are located on the entirety thereof in the circumferential direction thereof in the projected-portion-molding-setting regions with respect to the molding-surface side opening portion of the circumference-recess-inside pin hole 239A (ejector pin hole 239). The portions that are located in the projected-portion-molding-setting regions with respect to the molding-surface side opening portions of the storage-space connection ventilation passes 37 and the portions that are located in the projected-portion-molding-setting regions with respect to molding-surface side opening portions of the circumference-recess-outside pin hole 239B are also present in the tubular-projected-portion molding recesses 238 shown in FIGS. 9 and 10 as examples.

A portion which is not located in the projected-portion-molding-setting region is not present in the tubular-projected-portion molding recess 238c.

Note that, in the core die 230, a configuration may be adopted in which portions that are located in the projected-portion-molding-setting regions with respect to the molding-surface side opening portions of the storage-space connection ventilation passes 37 and the portions that are located in the projected-portion-molding-setting regions with respect to molding-surface side opening portions of the circumference-recess-outside pin hole 239B are not present in the tubular-projected-portion molding recesses 238.

Hereinbelow, the projected portion 2d of the resin molded product 2 is also referred to as a molded-product projected portion.

In the projected-portion-molding-setting regions with respect to the molding-surface side opening portions of the storage-space connection ventilation passes 37 and in the projected-portion-molding-setting regions with respect to the molding-surface side opening portions of the ejector pin holes 239, it is possible to effectively form the sink portion gap 15 when reduction in volume of the resin molded product 2 occurs due to lowering of the temperature thereof after molding. It is possible to cause the gas inside the gas storage space 36 or air (gas) outside a die (injection molding die) in a mold clamping state to enter between the inner surface of the projected-portion molding recess 238 of the core die 230 shown in FIGS. 9 and 10 and the molded-product projected portion 2d located thereinside through the sink portion gap 15.

It is possible to cause gas inside of the gas storage space 36 to enter between the inner surfaces of the rib molding recesses 238a and 238b and the ribs 2e and 2f (molded-product projected portion 2d) located thereinside through the storage-space connection ventilation pass 37 and the sink portion gap 15.

It is possible to cause air (gas) outside the injection molding die 210 in a mold clamping state to enter between the inner surface of the tubular-projected-portion molding recess 238c and the tubular projected portion 2g (molded-product projected portion 2d) located thereinside through the circumference-recess-inside pin hole 239A and the sink portion gap 15. With respect to a portion between the inner surface of the tubular-projected-portion molding recess 238c and the tubular projected portion 2g located thereinside through the storage-space connection ventilation pass 37 and the sink portion gap 15, it is possible to cause gas inside the gas storage space 36 to enter the portion, and it is possible to cause gas outside the injection molding die 210 in a mold clamping state to enter the portion through the circumference-recess-outside pin hole 239B and the sink portion gap 15.

The configuration that can cause gas (including air) to enter between the inner surfaces of the projected-portion molding recesses 238 and the molded-product projected portion 2d located thereinside through the sink portion gap 15 can increase a degree of flexibility in generation of sink that is caused by reduction in volume of the molded-product projected portion 2d due to lowering of the temperature thereof after molding. As long as the entirety of the opening portions of the projected-portion molding recesses 238 is configured to be located in the projected-portion-molding-setting regions with respect to the molding-surface side opening portions of the storage-space connection ventilation pass 37 or the ejector pin holes 239, gas can enter a wide region between the inner surfaces of the projected-portion molding recesses 238 and the molded-product projected portion 2d located thereinside, and therefore it is possible to increase a degree of flexibility in generation of sink in a wide region of the molded-product projected portion 2d. Accordingly, it is possible to concentrate the sink that is caused by reduction in volume of the molded-product projected portion 2d due to lowering of the temperature thereof after molding to the molded-product projected portion 2d, and it is possible to prevent sink from being generated at the portions of the design surface 2b of the resin molded product 2 which correspond to and are close to the molded-product projected portion 2d.

As a result of entering of the gas from the gas storage space 36 to between the inner surfaces of the rib molding recesses 238a and 238b and the ribs 2e and 2f, it is possible to ensure flexibility in sink on the ribs 2e and 2f which are molded by the rib molding recesses 238a and 238b.

All of the opening portions of the rib molding recesses 238a and 238b are located in the projected-portion-molding-setting regions with respect to the molding-surface side opening portions of the storage-space connection ventilation passes 37. Consequently, it is possible to cause gas to enter between the inner surfaces of the molding recesses 238a and 238b and the ribs 2e and 2f from the gas storage space 36 in the entire length in the extending direction of the rib molding recesses 238a and 238 which are formed in a groove shape. Therefore, in the molding the resin molded product 2 by use of the injection molding die 210, it is possible to reliably ensure flexibility in sink on the ribs 2e and 2f located thereinside in the entire length in the extending direction of the rib molding recesses 238a and 238 which are formed in a groove shape. As a result, in the molding of the resin molded product 2 by use of the injection molding die 210, the sink that is caused by reduction in volume of the ribs 2e and 2f occurs due to lowering of the temperature thereof after molding can be concentrated to the ribs 2e and 2f, it is possible to prevent sink from being generated at the portions of the design surface 2b of the resin molded product 2 which correspond to and are close to the ribs 2e and 2f.

Gas having a pressure higher than an atmospheric pressure is supplied between the inner surfaces of the rib molding recesses 238a and 238b and the ribs 2e and 2f located thereinside through the sink portion gap 15 from the gas storage space 36. When reduction in volume of the ribs 2e and 2f occurs due to lowering of the temperature thereof after molding, it is possible to promote generation of sink on the ribs 2e and 2f by operation of the gas pressure from the gas storage space 36 through the sink portion gap 15.

Furthermore, application of a gas pressure higher than an atmospheric pressure to the ribs 2e and 2f from the gas storage space 36 through the sink portion gap 15 is advantageous to separate the ribs 2e and 2f from the inner surfaces of the rib molding recesses 238a and 238b as compared with a case of applying gas having the same pressure as an atmospheric pressure to the ribs 2e and 2f from the sink portion gap 15. Accordingly, as long as a configuration of applying a gas pressure higher than an atmospheric pressure to the ribs 2e and 2f from the gas storage space 36 through the sink portion gap 15 is used, it is possible to separate the ribs 2e and 2f from the inner surfaces of the rib molding recesses 238a and 238b on a broader area as compared with the case of applying the same pressure as an atmospheric pressure to the ribs 2e and 2f from the sink portion gap 15, it is possible to freely generate sink on the ribs 2e and 2f.

Regarding the tubular projected portion 2g molded by the tubular-projected-portion molding recess 238c, flexibility in sink can be sufficiently ensured due to entering of air from the ejector pin hole 239 to a portion between the inner surface of the tubular-projected-portion molding recess 238c and the tubular projected portion 2g.

Since the entire opening portion of the tubular-projected-portion molding recess 238c is located in the projected-portion-molding-setting regions with respect to the molding-surface side opening portions of the ejector pin holes 239, air can enter from the ejector pin hole 239 to a portion between the inner surface of the tubular-projected-portion molding recess 238c and the tubular projected portion 2g on the entirety of the tubular-projected-portion molding recess 238c in the circumferential direction. Accordingly, in the molding of the resin molded product 2 by use of the injection molding die 210, flexibility in sink on the tubular projected portion 2g located thereinside can be reliably ensured on the entirety of the tubular-projected-portion molding recess 238c in the circumferential direction. As a result, in the molding of the resin molded product 2 by use of the injection molding die 210, since the sink that is caused by reduction in volume of the tubular projected portion 2g occurs due to lowering of the temperature thereof after molding can be concentrated to the tubular projected portion 2g, it is possible to prevent sink from being generated at the portions of the design surface 2b of the resin molded product 2 which correspond to and are close to the tubular projected portion 2g.

As compared with a configuration in which the molding-surface side opening portions of the ejector pin holes 239 is located outside the opening portions of the tubular-projected-portion molding recess 238c on the main-body back side molding surface 31, as shown in FIGS. 9 and 10, the configuration including the ejector pin holes 239 having the molding-surface side opening portions that are located in the circumference-recess-inside region 231a surrounded by the tubular-projected-portion molding recess 238c is advantageous to reduce the number of ejector pin holes 239 that are to be formed and necessary to cause the entirety of opening portion of the tubular-projected-portion molding recess 238c to be located in the projected-portion-molding-setting regions with respect to the molding-surface side opening portions of the ejector pin holes 239.

For example, in the case where the outer circumference of the opening portion of the tubular-projected-portion molding recess 238c is a square having a side of 100 mm, even where a configuration is adopted in which the molding-surface side opening portion of the circumference-recess-inside pin hole 239A is present in the central portion of the circumference-recess-inside region 231a at only one position, the entirety of the opening portion of the tubular-projected-portion molding recess 238c can be located in the projected-portion-molding-setting regions with respect to the molding-surface side opening portion of the circumference-recess-inside pin hole 239A.

In contrast, in a configuration in which the molding-surface side opening portion of the ejector pin hole 239 is only present outside the opening portion of the tubular-projected-portion molding recess 238c on the main-body back side molding surface 31, it is necessary to form a plurality of the ejector pin holes 239 in order to cause the entirety of the opening portion of the tubular-projected-portion molding recess 238c to be located inside the projected-portion-molding-setting regions with respect to the molding-surface side opening portions of the ejector pin holes 239.

As shown in FIGS. 9 and 10, in the configuration including the ejector pin holes 239 having the molding-surface side opening portions that are located in the circumference-recess-inside region 231a surrounded by the tubular-projected-portion molding recess 238c, when reduction in volume of the resin molded product 2 inside the cavity 14 occurs due to lowering of the temperature thereof after molding, entering of air into a portion between the circumference-recess-inside region 231a and the molded-product main body 2a is reliably realized.

gas that reaches the tubular-projected-portion molding recess 238c from the gas storage space 36 the storage-space connection ventilation pass 37 and through the sink portion gap 15 or air that reaches the tubular-projected-portion molding recess 238c from the gas pathways of the die parting portion of the injection molding die 210 in a mold clamping state through the sink portion gap 15 may enter or may not enter a portion between the circumference-recess-inside region 231a and the molded-product main body 2a over a portion between the tubular-projected-portion molding recess 238c and the molded-product projected portion 2d located thereinside. It is difficult to cause the gas inside the gas storage space 36 or air entering the inside of the cavity 14 from the die parting portion to reliably enter a portion between the circumference-recess-inside region 231a and the molded-product main body 2a.

According to the configuration including the ejector pin holes 239 having the molding-surface side opening portion that are located in the circumference-recess-inside region 231a, entering of air into a portion between the circumference-recess-inside region 231a and the molded-product main body 2a and thereby forming of the sink portion gap 15 can be reliably realized. As a result, in the injection molding die 210 including the ejector pin hole 239 having the molding-surface side opening portions that are located in the circumference-recess-inside region 231a, it is possible to freely generate sink at the portions that face the circumference-recess-inside region 231a of the molded-product main body 2a after molding, it is possible to prevent sink from being generated at the portions of the design surface 2b of the molded product which correspond to the circumference-recess-inside region 231a of the core die 230.

Note that, when reduction in volume of the resin molded product 2 inside the cavity 14 occurs due to lowering of the temperature thereof, the injection molding die 210 can cause gas or air to enter the entire portion between the main-body back side molding surface 31 and the molded-product main body 2a through the storage-space connection ventilation pass 37 that is communicated with the gas storage space 36, the gas pathways of the die parting portion, and the ejector pin holes 239.

In the molding of the resin molded product 2 by use of the injection molding die 210, it is possible to form the sink portion gap 15 on the entire portion between the main-body back side molding surface 31 and the molded-product main body 2a.

Additionally, in terms of increasing of a degree of flexibility in sink that is caused by reduction in volume of the tubular projected portion 2g inside the tubular-projected-portion molding recess 238c and occurs due to lowering of the temperature thereof after molding, the configuration is preferably adopted in which the ejector pin hole 239 having the molding-surface side opening portion (circumference-recess-inside pin hole 239A) located at the circumference-recess-inside region 231a and the ejector pin hole 239 having the molding-surface side opening portion (circumference-recess-outside pin hole 239B) located outside the opening portion of the tubular-projected-portion molding recess 238c on the main-body back side molding surface 31 are formed in the core die 230 and in which part of or all of the opening portion of the tubular-projected-portion molding recess 238c is located in the projected-portion-molding-setting region with respect to the molding-surface side opening portion of each ejector pin hole 239.

With this configuration, the injection molding die 210 can increase a degree of flexibility in generation of sink of the projected portion 2 of the resin molded product 2. Consequently, since the injection molding die 210 can concentrate the sink of the projected portion 2 to the projected portion 2 and can prevent sink from being generated at the portions of the design surface 2b of the resin molded product 2 which correspond to the molded-product projected portion 2d, it is possible to improve an external appearance of the resin molded product 2 (particularly, the design surface 2b).

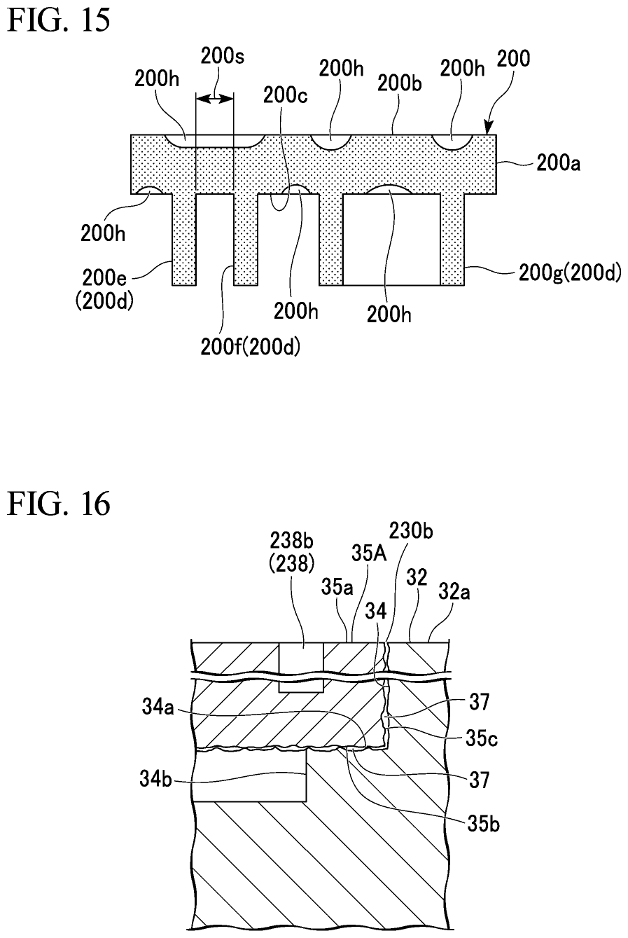

FIG. 15 is a cross-sectional front view showing a resin molded product 200 molded by use of an injection molding die (hereinbelow, also referred to as a non-ventilation pass die) having a configuration the gas storage space 36 and the storage-space connection ventilation pass 37 and the ejector pin holes 239 are omitted from the core die 230 of the injection molding die 210 of the injection molding die 210 shown in FIGS. 9 and 10.

A core die of the non-ventilation pass die which is used for molding of the resin molded product 200 of FIG. 15 is configured not to include a ventilation pass that opens at the main-body back side molding surface 231 and causes gas (may be air) to enter the inside of the cavity 14 from the outside of the cavity 14.

As shown in FIG. 15, the resin molded product 200 includes: a plate-shaped molded-product main body 200a; and projected portions 200d (molded-product projected portions) which protrude from a back surface 200c (molded-product-main-body back surface) that is on the opposite side of the design surface 200b on one surface of the molded-product main body 200a.

The resin molded product 200 includes: two ribs 200e and 200f that extend parallel to each other and serve as the projected portion 200d; and a tubular recess 200g. The resin molded product 200 is formed so as to have substantially the same configuration as that of the resin molded product 2 shown in FIGS. 11 and 12.

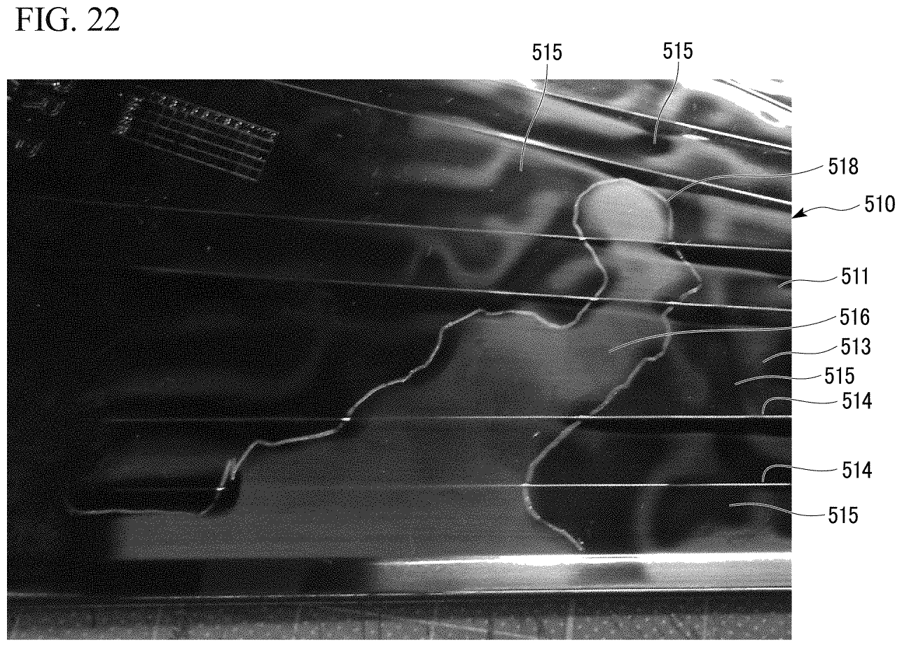

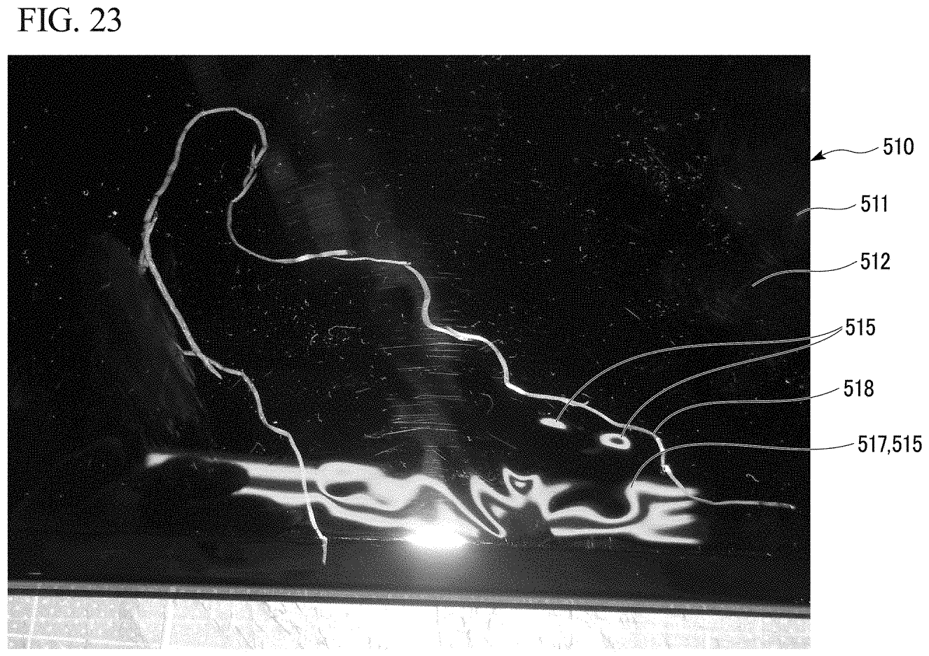

As shown in FIG. 15, in the resin molded product 200 molded by use of the non-ventilation pass die, sink portions 200h are easily formed near the positions of the design surface 200b which correspond to the ribs 200e and 200f and the tubular recess 200g. Furthermore, since the temperature of the design-surface molding surface of the cavity die during molding is substantially the same as the temperature of the portion of the inner surface of the cavity which is located at the core die, the design-surface molding surface and the core die are equal to each other in adhesive strength of the resin with respect to the cavity surface. As a result, sink portions 200h are randomly formed on the design surface and the opposite design surface (molded-product-main-body back surface 200c) (for example, refer to FIGS. 22 and 23).

Additionally, FIG. 15 shows the resin molded product 200 molded by the non-ventilation pass die in the case where a distance between two rib molding recesses 238e and 238b of the core die of the non-ventilation pass die which are separated and parallel to each other in the core die horizontal direction is less than or equal to 5 mm.

A separation distance 200s (a separation distance between ribs 200e and 200fa in the direction of a gap therebetween) between edges near the molded-product main body 200a of the two ribs 200e and 200f of the resin molded product 200 shown in FIG. 15 coincides with a distance between the separated two rib molding recesses 238e and 238b of the core die of the non-ventilation pass die in the core die horizontal direction (less than or equal to 5 mm).

Not only at the positions of the design surface 200b which correspond to and are close to the ribs 200e and 200f but also at a region including the entire region between the positions of the design surface 200b which correspond to the ribs 200e and 200f, the sink portions 200h are formed on the design surface 200b of the resin molded product 200 shown in FIG. 15.

In the description, an opening portion of the main-body back side molding surface 231 which is the ventilation pass that opens at the main-body back side molding surface 231 and causes gas (may be air) to enter the inside of the cavity 14 from the outside of the cavity 14 is also referred to as a molding-surface side opening portion.

From various verification, the inventor verified that, in the case where a distance between the separated two molded-product projected portions 200c such as the ribs 200e and 200f or the like which extend parallel to each other along the molded-product-main-body back surface 200c of the resin molded product 200 molded by use of the non-ventilation pass die is less than or equal to 5 mm, the sink portions 200h are conspicuously generated near the portions of the design surface 200b of the resin molded product 200 which correspond to the molded-product projected portions 200c.

Furthermore, the inventor understood that, even in the case of molding the resin molded product by use of an injection molding die having the ventilation pass opening at the core die main-body back side molding surface formed therein, when the portion that is located outside projected-portion-molding-setting region with respect to the molding-surface side opening portion of a ventilation pass of the core die is present at two molded-product projected portions that extend parallel to each other along the molded-product-main-body back surface and is separated at a distance of 5 mm or less, sink is conspicuously generated near the portions of the design surface of the molded product which correspond to the molded-product projected portion that is located outside the projected-portion-molding-setting region.

Regarding the aforementioned knowledge, as a result of verification by the inventor, in the molding the resin molded product 2 by use of the injection molding die 210 shown in FIGS. 9 and 10, even in the case where the distance 238s between the separated two rib molding recesses 238e and 238b of the core die 230 which are parallel to each other in the horizontal direction of the core die 230 is less than or equal to 5 mm, it was evaluated that sink can be prevented from being generated near the portions of the design surface 2b of the resin molded product 2 which correspond to the ribs 2e and 2f (refer to FIG. 12).

In the molding the resin molded product 2 by use of the injection molding die 210 according to the embodiment of the invention, even in the case where the distance 238s between the separated groove-shaped projected-portion molding recesses 238 of the core die 230 of the injection molding die 210 which are parallel to each other in the horizontal direction of the core die 230 is less than or equal to 5 mm, it is possible to prevent sink from being generated near the portions of the design surface 2b of the resin molded product 2 which correspond to the molded-product projected portion 2d.

Note that, sink formed in the molded-product projected portion 2d is not shown in FIG. 12.

The number of groove-shaped projected-portion molding recesses 238 which are parallel to each other and are formed in the core die 230 of the injection molding die 210 is not limited to two but may be three or more.

The configuration of each of the projected-portion molding recesses 238 of the groove-shaped projected-portion molding recesses 238 of the core die 230 of the injection molding die 210 which are parallel to each other is not limited to the configuration extending straight along the main-body back side molding surface 231 of the core die 230 (for example, the rib molding recesses 238e and 238b shown in FIGS. 9 and 10). Each of the groove-shaped projected-portion molding recesses 238 of the core die 230 of the injection molding die 210 which are parallel to each other may be formed in a curved shape having a predetermined length and extending on the main-body back side molding surface 231 of the core die 230 and may be a go-around groove or the like which is endless (go-around shape) and extends along the periphery of a circular shape or a polygonal shape such as a rectangular shape.

### (Another Embodiment of Gas Storage Space)

The gas storage space 36 of the core die 230 of the injection molding die 210 is not limited to the configuration ensured only be the recess 35d of the bushing 35 as shown in FIG. 9.

FIG. 16 shows a configuration using a bushing 35A in which the bushing back side recess 35d is omitted from the bushing 35 and having the gas storage space 36 ensured by a recess 34b (hereinbelow, also referred to as a core-die gas storage recess) that is formed on the core-die main body 32 so as to be depressed from the inside bottom surface 34a of the bushing storage recess 34. The gas storage space 36 shown in FIG. 16 is an inside space surrounded by the flat back surface 35b of the bushing 35A and inner surfaces of the core-die gas storage recess 34b. The gas storage space 36 shown in FIG. 16 has a configuration that is ensured only by the core-die gas storage recess 34b.

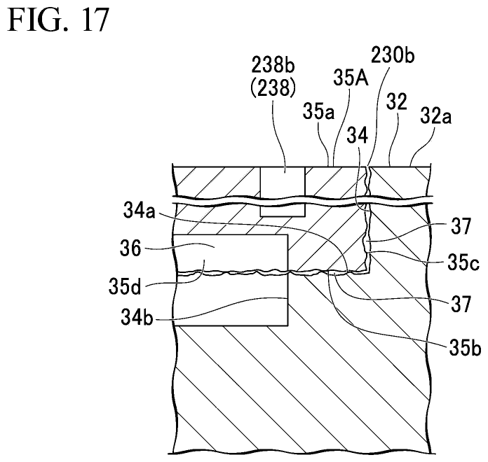

Additionally, as shown in FIG. 17, the gas storage space 36 may be a space ensured by the bushing back side recess 35d of the bushing 35 and the core-die gas storage recess 34b of the core-die main body 32.

Each of the bushings 35 and 35A forming the gas storage space 36 shown in FIGS. 16 and 17 as examples is fitted and fixed into the bushing storage recess 34 such that the inside bottom surface 34a located at the periphery of the opening portion of the core-die gas storage recess 34b of the bushing storage recess 34 of the core-die main body 32 is in contact with the back surface 35b.

The gas storage space 36 shown in FIGS. 9, 16, and 17 as an example is a space ensured between the bushings 35 and 35A and the inner surface of the bushing storage recess 34 by a recess formed on one or both of the bushings 35 and 35A, which cause the inside bottom surface 34a of the bushing storage recess 34 of the core-die main body 32 to come into contact with the back surface 35b, and the inner surface of the bushing storage recess 34 of the core-die main body 32.

### (Divided Bushing)

The core die is not limited to the configuration that accommodates only one bushing 35 in the bushing storage recess 34 of the core-die main body 32 (refer to FIG. 10).

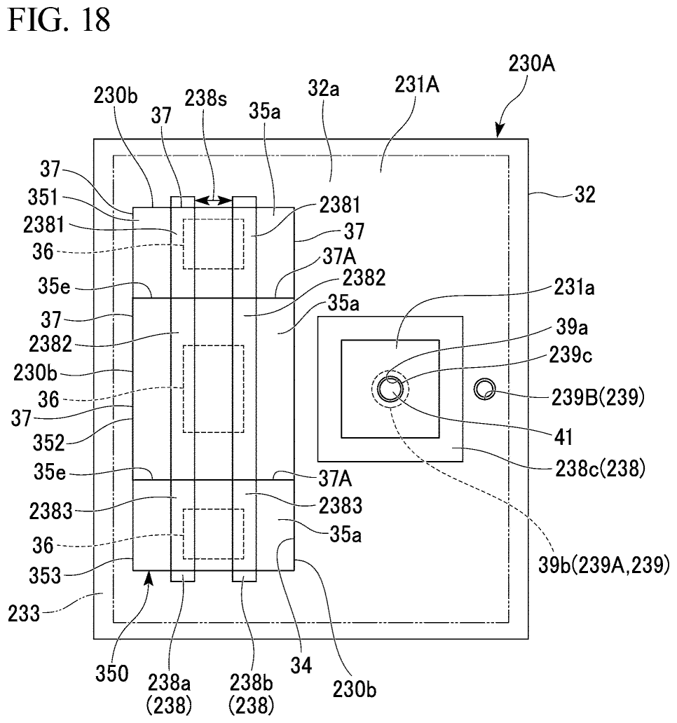

As shown in FIG. 18, as the core die, a configuration in which a plurality of bushings 351 to 353 are accommodated to the bushing storage recess 34 of the core-die main body 32 may be adopted. A top surface 35f (bushing top surface) that is continuous to the back side molding main surface 32a of the core-die main body 32 is formed on each of the bushings 351 to 353. A main-body back side molding surface 231A having a configuration in which the top surface 35f of each of the bushings 351 to 353 is continuous to the back side molding main surface 32a of the core-die main body 32 is present in a core die 230A shown in FIG. 18.

The core die 230A shown in FIG. 18 includes a divided bushing 350 configured by a plurality of bushings 351 to 353 that are accommodated in the bushing storage recess 34.

Projected-portion molding recesses 238 in which recess-divided portions 2381 to 2383 formed in the bushings 351 to 353 constituting the divided bushing 350, respectively, are continuous to each other are present in the divided bushing 350. Hereinbelow, the bushings 351 to 353 which constitute the divided bushing 350 is also referred to as a recess-divided-portion formation bushing. One part of the projected-portion molding recesses 238 (recess-divided portions 2381 to 2383) is formed on the top surface 35f of each of the recess-divided-portion formation bushings 351 to 353.

The recess-divided-portion formation bushings 351 to 353 shown in FIG. 18 is, for example, an impervious member formed by a metal member or the like.

The storage-space connection ventilation pass 37 that is formed by microscopic uneven portions between the side peripheral surfaces of the recess-divided-portion formation bushings 351 to 353 and the inner peripheral face of the bushing storage recess 34 is ensured in the bushing fitting matching portion 230b between the inner peripheral face of the bushing storage recess 34 the core-die main body 32 shown in FIG. 18 and the side peripheral surface of the divided bushing 350.

Moreover, a storage-space connection ventilation pass 37A that is formed by microscopic uneven portions of the side peripheral surfaces of the recess-divided-portion formation bushings 351 to 353 is also ensured in a matching portion 35e (hereinbelow, also referred to as a bushing matching portion) between the recess-divided-portion formation bushings 351 to 353 adjacent to each other in the core die 230A shown in FIG. 18.

One end of the storage-space connection ventilation pass 37A that is located at the bushing matching portion 35e opens at the end portion that is the portion exposed to the cavity 14 of the bushing matching portion 35e. Hereinbelow, the storage-space connection ventilation pass 37A having an end that opens at the end side of the bushing matching portion 35e which is exposed to the cavity 14 is also referred to as a bushing-intermediate ventilation pass.

The bushing-intermediate ventilation pass 37A is formed so as to extend from the bushing matching portion 35e to between a back surface of the recess-divided-portion formation bushing on both sides of the bushing matching portion 35e and a bottom surface of the bushing storage recess 34. The other end of the bushing-intermediate ventilation pass 37A which is on the opposite side of the cavity 14 opens at the gas storage space 36 that is ensured on the back surface of the recess-divided-portion formation bushing.

The bushing-intermediate ventilation pass 37A includes: a portion that is located at the bushing matching portion 35e; and a portion that is located between the back surface of the recess-divided-portion formation bushing on both sides of the bushing matching portion 35e and a bottom surface of the bushing storage recess 34. The portion of the bushing-intermediate ventilation pass 37A which is located between the back surface of the recess-divided-portion formation bushing on both sides of the bushing matching portion 35e and a bottom surface of the bushing storage recess 34 is ensured by microscopic uneven portions on each of the back surface of the recess-divided-portion formation bushing and the bottom surface of the bushing storage recess 34.

Specifically, the divided bushing 350 of the core die 230A shown in FIG. 18 has a configuration in which the bushing 35 shown in FIGS. 9 and 10 is divided into a plurality of parts in the extending direction of the rib molding recesses 238a and 238b.

In the divided bushing 350 shown in FIG. 18, the two rib molding recesses 238a and 238b (projected-portion molding recesses 238) are formed in parallel with each other. The recess-divided portions 2381 to 2383 which each are part of the rib molding recesses 238a and 238b are formed in the recess-divided-portion formation bushings 351 to 353 which constitute the divided bushing 350, respectively.

The divided bushing 350 has a configuration in which the recess-divided-portion formation bushings 351 to 353 are arrayed in a line and the rib molding recesses 238a and 238b (projected-portion molding recesses 238) are formed by continuously connecting the recess-divided portions 2381 to 2383 of the recess-divided-portion formation bushings 351 to 353.

As shown in FIG. 18, the inner surfaces of the projected-portion molding recesses 238 is also present in the bushing matching portion 35e between the recess-divided-portion formation bushings 351 to 353 adjacent to each other.

One ends of the bushing-intermediate ventilation passes 37A open at a portion which faces the projected-portion molding recess 238 of the bushing matching portion 35e.

In FIG. 18, the gas storage space 36 is ensured on a back surface side of each of the recess-divided-portion formation bushings 351 to 353. The gas storage space 36 on the back surface side of each of the recess-divided-portion formation bushings 351 to 353 is ensured by a recess formed on one or both of the back surface of the recess-divided-portion formation bushings 351 to 353 and the inside bottom surface of the bushing storage recess 34.

The projected-portion molding recesses 238 are connected to the gas storage space 36 such that vent such that ventilation is possible through the bushing-intermediate ventilation pass 37A of the bushing matching portion 35e.

In the molding of the resin molded product 2 by use of the injection molding die that is obtained by changing the core die 230 of the injection molding die shown in FIG. 9 to the core die 230A shown in FIG. 18, it is possible to cause the gas present in the cavity 14 to flow into the gas storage space 36 through the bushing fitting matching portion 230b and the storage-space connection ventilation passes 37 and 37A of the bushing matching portion 35e when injecting and filling of the molten resin to the cavity 14. Additionally, at this time, it is possible to cause the gas present in the projected-portion molding recesses 238 to flow into the gas storage space 36 through the bushing-intermediate ventilation pass 37A opening at the projected-portion molding recesses 238. As a result, when injecting and filling of the molten resin to the inside of the projected-portion molding recesses 238, the gas present in the projected-portion molding recesses 238 can be prevented from remaining, filling of the entirety of the inside of the projected-portion molding recesses 238 with the molten resin without occurrence of a space can be reliably realized.

Furthermore, when reduction in volume of the molded-product projected portions 2d (ribs 2e and 20 molded inside the rib molding recesses 238a and 238b occurs due to lowering of the temperature thereof, it is possible to cause the gas stored in the gas storage space 36 to flow between the inner surfaces of the rib molding recesses 238a and 238b (projected-portion molding recesses 238) and the molded-product projected portion 2d located thereinside through the bushing-intermediate ventilation pass 37A. Consequently, it is possible to freely generate sink over the broad area of the molded-product projected portion 2d. As a result, the sink that is caused by reduction in volume of the resin molded product 2 occurs due to lowering of the temperature thereof after molding can be further reliably concentrated to the molded-product projected portion 2d, it is possible to reliably prevent the sink from being generated near the portions of the design surface 2b of the molded product which correspond to the molded-product projected portion 2d.

The divided bushing 350 is assembled by the recess-divided-portion formation bushings 351 to 353 that are accommodated in the bushing storage recess 34.

The shapes of the recess-divided portions 2381 to 2383 of the recess-divided-portion formation bushings 351 to 353 can be appropriately modified.

The divided bushing 350 is advantageous to be able to easily obtain the projected-portion molding recesses 238 having various shapes by selectively using the recess-divided-portion formation bushings in which the recess-divided portions having various shapes are formed.

### (Modified Example of Projected-Portion Molding Recess)

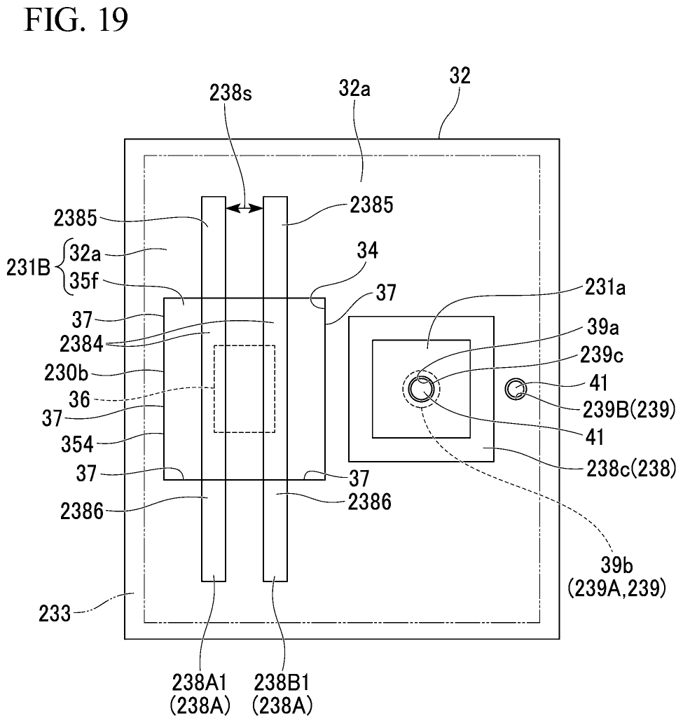

FIG. 19 shows a projected-portion molding recess 238A according to a modified example.

As a projected-portion molding recess of a core die, for example, a configuration in which recess-divided portions 2384 that are formed in the recess-divided-portion formation bushing 354 accommodated in the bushing storage recess 34 such as the projected-portion molding recess 238A shown in FIG. 19 are continuous to a recess-divided portion that is formed in the back side molding main surface 32a of the core-die main body 32 may be adopted.

The projected-portion molding recesses 238A shown in FIG. 19 as an example each have a configuration in which recess-divided portion 2384 that is formed in the recess-divided-portion formation bushing 354 accommodated in the bushing storage recess 34 is continuous to recess-divided portions 2385 and 2386 that are formed at both side portions of the bushing storage recess 34 of the back side molding main surface 32a of the core-die main body 32.

Specifically, the projected-portion molding recesses 238A shown in FIG. 19 as an example are groove-shaped rib molding recesses 238A1 and 238B1 that extend parallel to each other on a core die main-body back side molding surface 231B. Each of the recess-divided portion 2384 of the recess-divided-portion formation bushing 354 and the recess-divided portions 2385 and 2386 of the core-die main body 32 is part of the rib molding recesses 238A1 and 238B1 in the longitudinal direction thereof. The recess-divided portion 2384 of the recess-divided-portion formation bushing 354 and the back side molding main surface 32a of the core-die main body 32 are formed on the top surface 35f (bushing top surface) that constitutes the main-body back side molding surface 231B of the core die. The recess-divided portion 2384 of the recess-divided-portion formation bushing 354 includes central portions of the rib molding recesses 238A1 and 238B1 in the longitudinal direction.

The bushing fitting matching portion 230b between the recess-divided-portion formation bushing 354 and the inner surface of the bushing storage recess 34 is present between the recess-divided portion 2384 of the recess-divided-portion formation bushing 354 and the recess-divided portions 2385 and 2386 of the core-die main body 32. One end of the storage-space connection ventilation pass 37 that is ensured at the bushing fitting matching portion 230b opens at the inner surfaces of the projected-portion molding recesses 238A (rib molding recesses 238A1 and 238B1).

The projected-portion molding recesses 238A shown in FIG. 19 as an example is connected to the gas storage space 36 that is ensured at the back surface side of the recess-divided-portion formation bushing 354 such that ventilation is possible through the storage-space connection ventilation pass 37 of the bushing fitting matching portion 230b.

Note that, in FIG. 19, the gas storage space 36 is ensured on the back surface side of the recess-divided-portion formation bushing 354 by a recess formed on one or both of the back surface of the recess-divided-portion formation bushing 354 and the inside bottom surface of the bushing storage recess 34.

Although FIG. 19 shows the configuration including only one recess-divided-portion formation bushing 354 that is accommodated in the bushing storage recess 34, the number of recess-divided-portion formation bushings 354 that are accommodated in the bushing storage recess 34 may be two or more.

Moreover, the recess-divided portions of the back side molding main surface 32a of the core-die main body 32 are not limited to the configuration of being formed on each sides of the bushing storage recess 34 of the back side molding main surface 32a, the configuration of being formed on only one of the sides of the bushing storage recess 34 of the back side molding main surface 32a may also be adopted. In the case where a recess-divided portion is formed on only one of the sides of the bushing storage recess 34 of the back side molding main surface 32a of the core-die main body 32, a bushing in which a recess-divided portion is not formed on the opposite side of the recess-divided portion of the core-die main body 32 via the recess-divided-portion formation bushing 354 of the bushing storage recess 34 may be accommodated therein.

(Adoption Example of Bushing Having Configuration of being Formed of Porous Member)

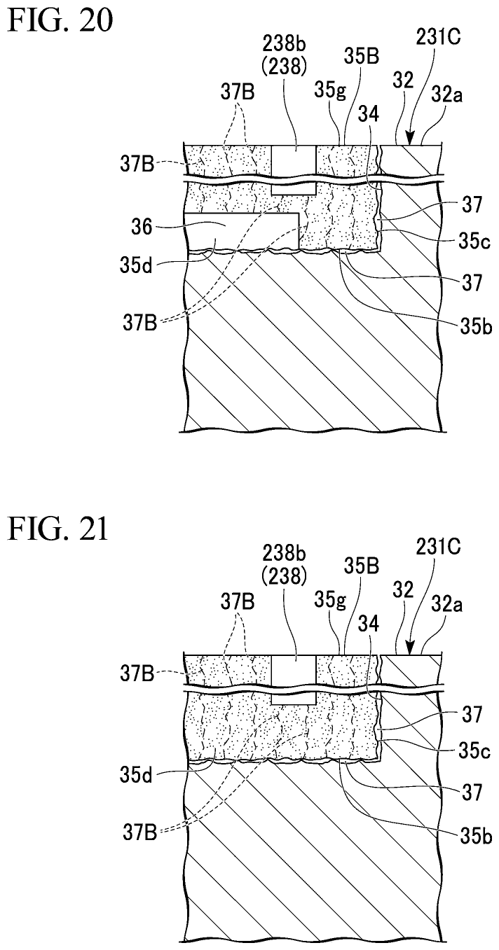

As shown in FIG. 20, as the bushing 35B to be accommodated in the bushing storage recess 34 of the core-die main body 32, instead of the bushing 35 formed of an impervious member, a structure which is formed of an porous member having excellent heat resistance and an aeration property such as ceramics or the like (hereinbelow, also referred to as a porous bushing) can also be adopted.

A plurality of air holes are formed in the porous bushing 35B. A plurality of ventilation passes 37B (storage-space connection ventilation pass) that cause the gas storage space 36 to be communicated with the cavity 14 such that ventilation is possible by the air holes are ensured in the porous bushing 35B. Hereinbelow, the storage-space connection ventilation pass 37B of the porous bushing 35B is also referred to as a bushing-air-hole ventilation pass.

The porous bushing 35B shown in FIG. 20 is different from the bushing 35 of the core die 230 shown in FIGS. 9 and 10 only in that the porous bushing is formed of a porous member having an aeration property. The configuration other than the formation material of the porous bushing 35B is the same as that of the bushing 35 of the core die 230 shown in FIGS. 9 and 10.

A position of a top surface 35g (bushing top surface) on the opposite side of the inside bottom surface 34a of the bushing storage recess 34 of the porous bushing 35B shown in FIG. 20 is fixed so as to be continuously connected to the back side molding main surface 32a of the core-die main body 32. The bushing top surface 35g of the porous bushing 35B and the back side molding main surface 32a of the core-die main body 32 constitute a core die main-body back side molding surface 231C.

A plurality of opening portions located at one end of the bushing-air-hole ventilation pass 37B are present on the entirety of the top surface 35g of the porous bushing 35B. Therefore, the opening portions can be widely present at one end of the storage-space connection ventilation pass on the main-body back side molding surface 231C of the core die which adopts the porous bushing 35B as compared with the case of adopting the bushing 35 formed of an impervious member.

Consequently, for example, when injecting and filling of the molten resin to the cavity 14 of the injection molding die that is obtained by changing the bushing 35 of the core die 230 of the injection molding die 210 shown in FIG. 9 to the porous bushing 35B, a gas flow from the cavity 14 to the gas storage space 36 can be reliably and smoothly realized through the bushing-air-hole ventilation pass 37B.

The porous bushing 35B can cause the opening portions located at one side (one end) of the bushing-air-hole ventilation pass 37B to be present at a plurality of portions on the entire inner surfaces of the projected-portion molding recesses 238.

Accordingly, for example, in the molding of the resin molded product 2 by use of the injection molding die that is obtained by changing the bushing 35 of the core die 230 of the injection molding die 210 shown in FIG. 9 to the porous bushing 35B, when reduction in volume of the resin molded product 2 occurs due to lowering of the temperature after molding, it is possible to cause the gas inside the gas storage space 36 to widely flow between the inner surfaces of the projected-portion molding recesses 238 and the molded-product projected portion 2d located thereinside through the bushing-air-hole ventilation pass 37B.

As a result, it is possible to increase a degree of flexibility in generation of sink on a broad area of the molded-product projected portion 2d inside the projected-portion molding recesses 238, and it is possible to reliably prevent sink from being generated at the portions of the design surface 2b of the molded product which correspond to the molded-product projected portion 2d.

Furthermore, even where the distance of the separated projected-portion molding recesses 238 (rib molding recesses 238a and 238b) in the horizontal direction of the core shape 230 which extend parallel to each other is less than or equal to 5 mm, the porous bushing 35B can cause the gas inside the gas storage space 36 to enter a portion between the main-body back side molding surface 231 that is located between the projected-portion molding recesses 238 and the molded-product main body 2a through the bushing-air-hole ventilation pass 37B of the porous bushing 35B that opens between the projected-portion molding recesses 238 of the top surface 231c (bushing top surface).

Accordingly, by adopting the porous bushing 35B, it is possible to reliably ensure flexibility in generation of sink at a region between the molded-product projected portions 2d which extend parallel to each other at a separation distance of 5 mm or less on the back surface 2c of the molded-product main body 2a. As long as the configuration adopting the porous bushing 35B is used, it is also possible to reliably prevent sink from being generated at a region between the portions of the design surface 2a of the molded product which correspond to the molded-product projected portions 2d extending parallel to each other.

Furthermore, by adopting the porous bushing 35B, when injecting and filling of the molten resin to the cavity 14, it is possible to cause the gas present in the projected-portion molding recesses 238 to flow into the gas storage space 36 through the bushing-air-hole ventilation pass 37B of the porous bushing 35B. For this reason, there is an advantage in that the remaining gas present in the projected-portion molding recesses 238 is eliminated and it is possible to easily and reliably realize the filling of the entirety of the projected-portion molding recesses 238 with the molten resin without occurrence of a space.

Use of the bushing formed of a porous member and having an aeration property instead of the bushing formed of an impervious member is also applicable to the bushings 35 and 35A shown in FIGS. 16 and 17.

The bushing that forms a connection pass is also applicable to the recess-divided-portion formation bushing (for example, the recess-divided-portion formation bushing shown in FIGS. 18 and 19).

Particularly, in the case of using the porous bushing, a high-pressure gas can be stored inside the porous bushing by, for example, using a porous bushing (bushing) having a size such that the bushing is implanted in the entirety of the bushing storage recess 34 without separately providing a space for gas storage in a core die.

In the case of using the porous bushing having a size such that the bushing is implanted in the entirety of the bushing storage recess 34, the air holes of the bushing function as a gas storage space.

As shown in FIGS. 22 to 27, the inventor carried out molding of a resin molded product by use of each of an injection molding die (hereinbelow, a ventilation-pass die) having ventilation pass such as ejector pin holes or the like and a non-ventilation pass die.

Note that, the molding of the resin molded product were carried out in both cases of using the ventilation-pass die and the using the non-ventilation pass die, the temperatures of a cavity die and a core die are substantially the same as each other.

FIGS. 22 and 23 show a resin molded product that was molded by use of the non-ventilation pass die.

FIG. 22 is a photograph obtained by capturing a back surface side (opposite side of a design surface) of a resin molded product 510 as an image, and FIG. 23 is a photograph obtained by capturing the design surface 512 of the resin molded product 510 as an image.

As shown in FIG. 22, although a plurality of scribed lines 514 extending in substantially the same direction as each other are formed so as to be spaced apart at a distance on a back surface 513 (hereinbelow, also referred to as a molded-product-main-body back surface) which is on the opposite side of the design surface of a molded-product main body 511 of the resin molded product 510, a rib that brings a concern about generation of sink is not set. A non-sink region 516 serving as a smooth surface on which sink portion is not present was formed over regions between the scribed lines 514 on the molded-product-main-body back surface 513 so as to extend thereon. A marking 518 was provided around the periphery of the non-sink region 516 on the molded-product-main-body back surface 513. Additionally, sink portions 515 were present at a plurality of portions that are located at the periphery of the non-sink region 516 of the molded-product-main-body back surface 513.

As shown in FIG. 23, the markings 518 are provided at positions around the periphery of the non-sink region 516 of the molded-product-main-body back surface 513 on the design surface 512 of the molded-product main body 511 of the resin molded product 510.

As shown in FIG. 23, an image 517 of a light source that illuminates the design surface 512 with illuminating light can be observed on the design surface 512 of the resin molded product 510. However, it is understood from distortion of the image 517 of the light source that the sink portions 515 are present on a region of the design surface 512 which corresponds to the non-sink region 516 of the molded-product-main-body back surface 513. Furthermore, on a region of the design surface 512 which corresponds to the non-sink region 516 of the molded-product-main-body back surface 513, it is understood from light reflection that the sink portions 515 are also present at positions separated from the sink portion 515 which is found by the image 517 of the light source.

On the molded-product main body 511 of the resin molded product 510 shown in FIGS. 22 and 23, the sink portions 515 are formed on both the design surface 512 and the back surface 513.

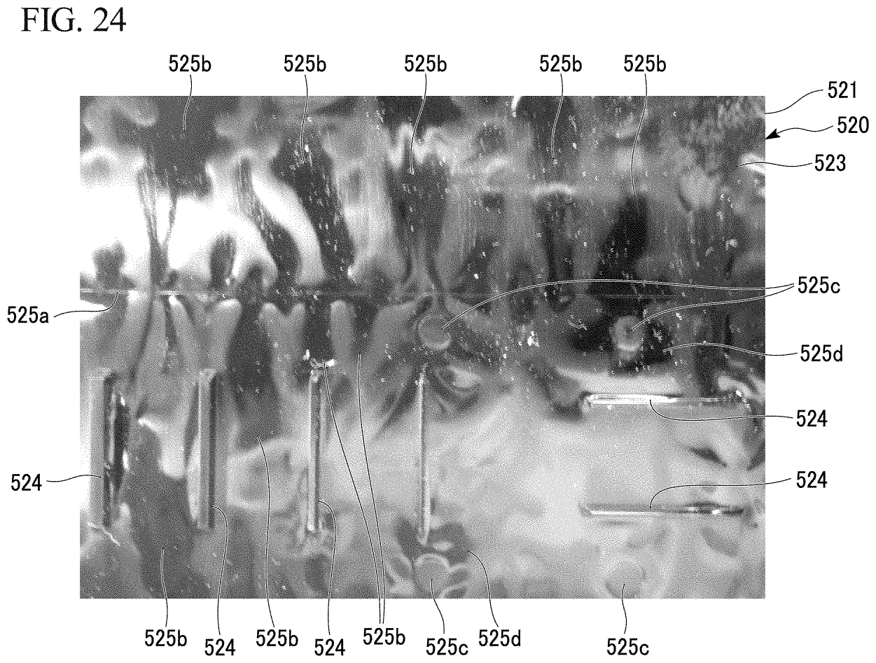

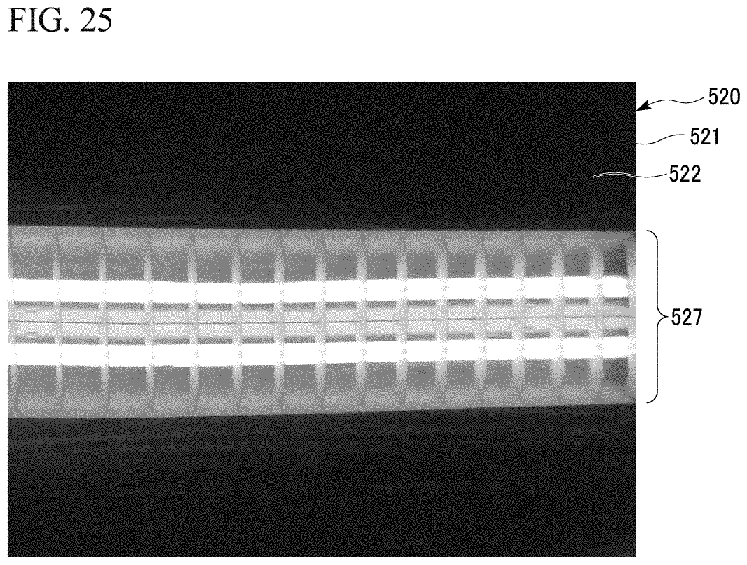

FIGS. 24 and 25 show an example of a resin molded product molded by use of the ventilation-pass die.

FIG. 24 is a photograph obtained by capturing a back surface side (opposite side of a design surface) of a resin molded product 520 as an image, and FIG. 25 is a photograph obtained by capturing the design surface 522 of the resin molded product 520 as an image.

The ventilation-pass die that is used to mold the resin molded product 520 shown in FIGS. 24 and 25 uses a core die having a configuration in which a bushing is fitted into a bushing storage recess of a core-die main body and a gas storage space is ensured between an inside bottom surface the bushing storage recess and the bushing. A ventilation pass (storage-space connection ventilation pass) that is communicated with the gas storage space and opens at a core die main-body back side molding surface is ensured between an inner peripheral face of the bushing storage recess and the bushing.

As shown in FIG. 24, a groove-shaped sink portion 525a is formed at a position on an back surface 523 (hereinbelow, also referred to as a molded-product-main-body back surface) which is on the opposite side of the design surface of a molded-product main body 521 of the resin molded product 520 and correspond to the storage-space connection ventilation pass of the core die.

FIG. 24 shows part of the molded-product-main-body back surface 523.

In FIG. 24, the groove-shaped sink portion 525a extends straight and crosses over an image area of the molded-product-main-body back surface 523 shown in FIG. 24.

It is conceivable that, the groove-shaped sink portion 525a was formed due to discharge of gas inside a gas storage space of a core die to between the molded-product-main-body back surface 523 of the resin molded product 520 and the core die through a storage-space connection ventilation pass in accordance with reduction in volume of the resin molded product 520 along with cooling after molding inside the ventilation-pass die. Additionally, sink portions 525b (hereinbelow, matching-surrounding sink portions) of the molded-product-main-body back surface 523 which were thought to be progressed and formed along with the discharge of the gas from the storage-space connection ventilation pass are formed on the molded-product-main-body back surface 523 so as to extend from the groove-shaped sink portion 525a. The matching-surrounding sink portions 525b extending from the groove-shaped sink portion 525a is formed at a plurality of positions in the extending direction of the groove-shaped sink portion 525a. Furthermore, the matching-surrounding sink portions 525b are each present on both regions of the molded-product-main-body back surface 523 via the groove-shaped sink portion 525a.

A plurality of ribs 524 are formed on one of the regions (a region under the groove-shaped sink portion 525a in FIG. 24) of the molded-product-main-body back surface 523 via the groove-shaped sink portion 525a.

The portions on the molded-product-main-body back surface 523 at which the ribs 524 are located on the groove-shaped sink portion 525a are a region (core-die main body region) corresponding to the core-die main body of the core die when molding of the resin molded product 520. A region on the opposite side of the core-die main body region via the groove-shaped sink portion 525a is a region (bushing region) corresponding to a bushing of the core die.

A circular-shaped sink portion 525c that is thought to be formed due to suctioning (discharge) of air from ejector pin holes to a portion between the molded-product-main-body back surface 523 of the resin molded product 520 and the core die in accordance with reduction in volume of the resin molded product 520 along with cooling after molding is present on the core-die main body region of the molded-product-main-body back surface 523. Furthermore, sink portions 525d (hereinbelow, also referred to as a pin-hole surrounding sink portion) which were thought to be progressed and formed on the molded-product-main-body back surface 523 so as to extend from the circular-shaped sink portion 525c along with suctioning of air from the ejector pin holes are also present around the circular-shaped sink portion 525c.

As shown in FIG. 25, the design surface 522 of the molded-product main body 521 of the resin molded product 520, it is possible to clearly observe an image 527 of a light source that illuminates the design surface 522 with illuminating light.

The light source of the image 527 that can be observed on the design surface 522 shown in FIG. 25 is a fluorescent lamp lighting device. As the fluorescent lamp lighting device, in order to detect distortion of the image 527 on the design surface 522, a fluorescent lamp lighting device is used which includes: a plurality of linear fluorescent lamps that are supported in parallel to each other; and plates that are disposed perpendicularly to the fluorescent lamps at a plurality of positions in the longitudinal direction of the fluorescent lamps.

As a result of observation of the design surface 522 shown in FIG. 25, it was understood that distortion does not occur in the image 527 of the light source shown on the design surface 522, reflection light due to presence of sink portions is not found over the entirety of the design surface 522, and sink portion is not present on the design surface 522.

Moreover, it is visually determined that a mirror surface on which uneven portions are not locally present is formed on the design surface 522.

As described above, although the invention has been described with reference to a best mode, the invention is not limited to the aforementioned best mode, various modifications may be made without departing from the inventions.

The core die of the injection molding die not limited to the configuration in which the gas storage space 36, the storage-space connection ventilation pass, the ejector pin hole 39 are present, and a configuration in which only one of the gas storage space 36, the storage-space connection ventilation pass, and the ejector pin hole 39 is present may be adopted.

Furthermore, as a ventilation pass that is present in the core die, for example, a through ventilation hole or the like which has an internal diameter of approximately several microns to several tens of microns and is formed to penetrate through the core die may be adopted. The through ventilation hole has a configuration in which one end thereof opens at the core die main-body back side molding surface and the other end thereof opens at an outer surface of the core die.

### DESCRIPTION OF REFERENCE NUMERALS

1 . . . resin molded product, 1a . . . molded-product main body, 1b . . . design surface (of the resin molded product), 1c . . . back surface (of the resin molded product), 1d . . . projected portion (of the resin molded product), 1e, 1f . . . projected portion (of the resin molded product) (side rib), 1g . . . projected portion (of the resin molded product) (intermediate rib), 2 . . . resin molded product, 2a . . . molded-product main body, 2b . . . design surface (of the resin molded product), 2c . . . back surface (of the resin molded product), 2d . . . projected portion (of the resin molded product), 2e, 2f . . . projected portion (of the resin molded product) (rib), 2g . . . projected portion (tubular projected portion) (of the resin molded product), 10 . . . injection molding die, 11 . . . cavity, 12 . . . temperature regulation mechanism, 13 . . . sink portion gap, 14 . . . cavity, 15 . . . sink portion gap, 20 . . . cavity die, 21 . . . molding recess, 22 . . . design-surface molding surface (bottom surface of the molding recess), 23 . . . parting surface, 30 . . . second die (core die), 30a . . . bottom surface of the core die, 30b . . . intermediate-recess formation region, 31 . . . main-body back side molding surface, 31a . . . back side molding main surface, 32 . . . core-die main body, 33 . . . parting surface, 34 . . . bushing storage recess, 34a . . . inside bottom surface of the bushing storage recess, 34b . . . core-die gas storage recess, 35, 35A . . . bushing, 35B . . . bushing (porous bushing), 35a . . . top surface (of the bushing), 35b . . . back surface (of the bushing), 35c . . . side peripheral surface (of the bushing), 35d . . . bushing back side recess, 35e . . . bushing matching portion, 35f, 35g . . . top surface (of the bushing), 36 . . . gas storage space, 37, 37A, 37B . . . ventilation pass (storage-space connection ventilation pass), 38 . . . projected-portion molding recess, 38a . . . projected-portion molding recess (first side recess), 38b . . . projected-portion molding recess (second side recess), 38c . . . projected-portion molding recess (intermediate recess), 39 . . . ventilation pass, ejector pin hole, 39a . . . ventilation pass, pin-hole ventilation pass, 121 . . . cavity die heating mechanism, 121a . . . heating pipe, 121b . . . connection pipe, 121c . . . fluid heating feeding portion, 122 . . . core die heating mechanism, 122a . . . heating pipe, 122b . . . connection pipe, 122c . . . fluid heating feeding portion, 210 . . . injection molding die, 220 . . . cavity die, 221 . . . molding recess, 222 . . . design-surface molding surface (bottom surface of the molding recess), 223 . . . parting surface, 230, 230A, 230B . . . second die (core die), 230a . . . bottom surface of the core die, 230b . . . bushing fitting matching portion, 231, 231A to 231C . . . main-body back side molding surface, 231a . . . circumference-recess-inside region, 333 . . . parting surface, 238 . . . projected-portion molding recess, 238a, 238b, 238A1, 238B1 . . . projected-portion molding recess (rib molding recess), 238c . . . projected-portion molding recess (tubular-projected-portion molding recess), 239 . . . ventilation pass, ejector pin hole, 239A . . . ventilation pass, ejector pin hole (circumference-recess-inside pin hole), 239B . . . ventilation pass, ejector pin hole (circumference-recess-outside pin hole), 239c . . . ventilation pass, pin-hole ventilation pass, 350 . . . divided bushing, 351 to 354 . . . recess-divided-portion formation bushing, 2381 to 2386 . . . recess-divided portion, 520 . . . resin molded product, 521 . . . molded-product main body, 522 . . . design surface, 523 . . . back surface (of the molded-product main body), 524 . . . projected portion (rib), 525a . . . groove-shaped sink portion, 525b . . . matching portion circumference wall, 525c . . . circular sink portion, 525d . . . pin-hole peripheral sink portion, 527 . . . image (of a light source).

1. An injection molding die, comprising:
a cavity die having a molding recess formed thereon, the molding recess molding a molded-product main body on which a design surface of a resin molded product is formed; and
a core die that exists to be openable and closable with respect to the cavity die and forms a cavity having the molding recess between the cavity die and the core die, when the core die is closed and coupled to the cavity die,
the injection molding die being used in a resin molding method of causing a design surface of the resin molded product during molding to be brought into close contact with the cavity die by setting temperatures of the cavity die and the core die to be higher than or equal to a deformation temperature of a resin to be molded, wherein
the core die has a back side molding surface, a projected-portion molding recess, and a ventilation pass, which are formed therein,
the back side molding surface molds a back surface side on an opposite side of a top surface side on which the design surface is to be formed, by use of an inner surface of the molding recess of the cavity die of the molded-product main body,
the projected-portion molding recess molds a projected portion that is depressed from the back side molding surface and protrudes from a back surface of the molded-product main body,
the ventilation pass is formed to open at the back side molding surface and introduces gas from an outside of the cavity into an inside of the cavity, and
an entirety of the back side molding surface of the core die is located in a range of 100 mm which is a shortest distance from an opening portion of the ventilation pass of the back side molding surface of the core die along the back side molding surface.

2. The injection molding die according to claim 1, wherein
the core die has a tubular-projected-portion molding recess and the ventilation pass which are formed therein,
the tubular-projected-portion molding recess is the projected-portion molding recess on which an opening portion endlessly extends on the back side molding surface, and molds the projected portion that surrounds a region of a part thereof and is formed in a tubular shape on a back surface of the molded-product main body, and
the ventilation pass opens at an inside region surrounded by the tubular-projected-portion molding recess of the back side molding surface.

3. The injection molding die according to claim 1, wherein
the ventilation pass is an ejector pin hole that accommodates an ejector pin therein.

4. The injection molding die according to claim 1, wherein
the core die includes:
a core-die main body that forms a back side molding main surface that is part of the back side molding surface; and
a bushing that is fixed to an inside of a bushing storage recess depressed from the back side molding main surface of the core-die main body, wherein
a bushing top surface that is part of the back side molding surface is formed on the bushing, wherein
a gas storage space is ensured between the bushing and the core-die main body by a recess formed on one or both of an inner surface of the bushing storage recess and the bushing, and
the gas storage space is connected to the cavity so as to be able to ventilate thereto via the ensured ventilation pass between an inner peripheral face of the bushing storage recess of the core-die main body and the bushing or in the bushing.

5. The injection molding die according to claim 4, wherein
the core die includes a recess-divided-portion formation bushing serving as the bushing on which a recess-divided portion that is part of the projected-portion molding recess is formed, and
one end of the ventilation pass opens at an inner surface of the projected-portion molding recess, and the ventilation pass is ensured at a matching portion between an inner peripheral face of the bushing storage recess of the core-die main body having part of the projected-portion molding recess formed therein and the recess-divided-portion formation bushing or a matching portion between the recess-divided-portion formation bushings.
